(19) United States
(12) Patent Application Publication
(10) Pub. No.: US 2026/0370491 A1
(43) Pub. Date: Nov. 19, 2026

(54) LEDGER-ENFORCED INSTRUCTION-SET ARCHITECTURE AND COMPATIBLE COMPILER AND VIRTUAL-MACHINE STACK

(71) Applicant: Jonathan Washburn, Austin, TX (US)

(72) Inventor: Jonathan Washburn, Austin, TX (US)

(21) Appl. No.: 19/676,135

(22) Filed: May 13, 2026

Related U.S. Application Data
(60) Provisional application No. 63/805,951, filed on May 14, 2025.

(51) Int. Cl. H04L 9/32

(52) U.S. Cl. CPC H04L 9/3247; H04L 9/3239; H04L 9/3263

(57) ABSTRACT

A ledger-enforced instruction-set architecture, compiler, virtual machine, and executable format are disclosed. Executable opcodes include balance-class metadata designating signed algebraic contributions. Execution is organized into frames of exactly eight opcodes. During execution, a hardware or software balance accumulator accumulates the signed contributions of the opcodes in a frame. At a frame boundary, identified by an execution-frame flag or other boundary indication, the accumulated frame balance is compared with zero. Architectural or virtual-machine state is permitted to commit only when the accumulated frame balance equals zero. If the accumulated frame balance is nonzero, commit is prevented and a non-commit response, such as rollback, speculative-state discard, trap, exception, refusal, or safe-state entry, is performed. A compatible compiler may generate balanced eight-opcode frames and ledger-conformance metadata, and a compatible virtual machine or loader may enforce or verify the same frame-balance rule.

### CROSS-REFERENCE TO RELATED APPLICATIONS

This application claims the benefit of priority to U.S. Provisional Patent Application No. 63/805,951, filed May 14, 2025, the entire contents of which are incorporated herein by reference.

### BACKGROUND

The present disclosure relates to computer processor instruction-set architecture, compiler construction, virtual-machine execution, binary executable formats, and fault-tolerant computation. More particularly, the present disclosure relates to an instruction-set architecture in which executable opcodes encode algebraic balance semantics within bounded eight-opcode execution frames, and to compatible compiler, loader, hardware, firmware, microcode, and virtual-machine components that enforce a zero-balance commit rule for each execution frame. Conventional instruction-set architectures generally permit instructions to execute and commit according to ordinary instruction semantics, program order, pipeline retirement rules, transactional memory rules, or other architectural ordering mechanisms. Such instruction-set architectures typically do not require a bounded frame of executed instructions to satisfy an algebraic neutrality condition before architectural state is permitted to commit. As a result, correctness, fault tolerance, and integrity assurance are often delegated to software testing, compiler checks, redundancy schemes, parity mechanisms, error-correcting memory, checkpointing systems, assertions, transactional execution, or post-execution verification. Existing fault-tolerant approaches provide useful protection in many computing environments, but they also present limitations. Triple modular redundancy, dual execution with comparison, lockstep processors, and related duplication-based approaches can impose substantial area, power, latency, or cost overhead. Checkpointing can provide recovery from detected failures, but checkpoint intervals may be coarse relative to individual instruction execution, and recovery may require undo logs, memory snapshots, or software-managed rollback. Parity and error-correcting codes can protect stored or transmitted bits, but they do not generally enforce an algebraic relationship among executed instructions in a bounded execution frame before state commitment. Software assertions and runtime checks depend on programmer instrumentation, compiler insertion, runtime policy, or application-level logic, and may not provide an architectural commit gate at the instruction-set level.

In many processors and virtual machines, an instruction may produce an erroneous result, a corrupted side effect, or a tampered execution state that is not detected until a later software check, memory check, exception, redundant comparison, or external verification step. Even where transactional memory or checkpointing is available, a transaction or checkpoint boundary is not typically defined by a signed algebraic contribution carried by each opcode and accumulated across a fixed eight-opcode execution frame. Thus, conventional mechanisms generally do not require each opcode in a frame to carry balance metadata, do not accumulate signed frame contributions as part of instruction execution, and do not prevent architectural or virtual-machine state from committing unless the accumulated frame balance equals zero at the frame boundary.

There remains a need for a computing architecture in which executable instructions themselves carry balance metadata, in which execution is organized into bounded frames, and in which state commitment is gated by a zero-sum condition over the executed frame. There is also a need for a compatible compiler and virtual-machine stack that can generate, verify, interpret, and enforce such ledger-conformant code across hardware and software execution environments.

The present disclosure addresses these and other limitations by embedding algebraic balance semantics into instruction encoding and by requiring that exactly eight-opcode execution frames satisfy a zero-balance condition before architectural or virtual-machine state is committed. In disclosed embodiments, each opcode carries a balance-class field designating a signed algebraic contribution, the signed contributions are accumulated in a balance accumulator over an eight-opcode execution frame, and a frame-boundary indication causes the accumulated balance to be compared with zero. If the accumulated frame balance equals zero, state may commit. If the accumulated frame balance is nonzero, commit is prevented and a non-commit response, such as rollback, trap, exception, refusal, safe-state entry, or speculative-state discard, may be performed. This commit discipline provides instruction-level ledger enforcement rather than merely after-the-fact error detection.

### SUMMARY

A ledger-enforced instruction-execution architecture is disclosed. In the core architecture, executable opcodes carry balance-class metadata designating signed algebraic contributions, exactly eight opcodes form an execution frame, an execution-frame boundary is identified at the final opcode or final frame slot, signed contributions are accumulated in a balance accumulator over the frame, and architectural or virtual-machine state is permitted to commit only when the accumulated frame balance equals zero at the frame boundary. If the accumulated frame balance is nonzero, commit is prevented and an execution engine performs a non-commit response, such as rolling back state, discarding speculative state, trapping, raising an imbalance exception, refusing execution, entering a safe state, or invoking another recovery or diagnostic response.

In some embodiments, each opcode is a fixed-length instruction word including a primary opcode field, a balance-class field, a frame-boundary indication field, and one or more operand fields. In preferred embodiments, each opcode is a 32-bit instruction word including a primary opcode field, a 3-bit balance-class field, a 1-bit execution-frame flag, a destination-register field, and an immediate, source-register, or operand field. The 32-bit format is a preferred implementation and does not limit the broader balance-class and frame-boundary architecture.

In some embodiments, the balance-class field identifies a contribution class according to a contribution map. The contribution map may assign a positive signed contribution to one or more positive classes, a negative signed contribution to one or more negative classes, and a neutral contribution to one or more neutral classes. In preferred embodiments, the contribution map assigns +1 to an arithmetic-add class, −1 to an arithmetic-subtract class, and 0 to one or more logic, memory, branch, ledger-operation, reserved, or vendor-defined classes. In alternative embodiments, the contribution map may assign bounded signed integer values, signed fixed-point values, multiple positive contribution levels, multiple negative contribution levels, or implementation-defined values, provided that the execution frame is evaluated against a zero-balance commit condition.

In some embodiments, a balance accumulator accumulates the signed contributions of the opcodes in an execution frame. The balance accumulator may be implemented in hardware, firmware, microcode, software, a virtual machine, or a hybrid execution environment. In preferred hardware embodiments, the balance accumulator is a signed balance register, such as a 128-bit signed two's-complement register. In virtual-machine embodiments, the balance accumulator may be a software integer, fixed-width value, arbitrary-precision value, or host-native signed value.

In some embodiments, the execution-frame boundary is identified by an explicit execution-frame flag in the final opcode of the eight-opcode frame. In other embodiments, the boundary is identified by an implicit eight-slot frame counter, reserved boundary opcode, instruction-prefix metadata, binary frame-attestation table, virtual-machine bytecode metadata, microcode state, or another boundary indication that identifies completion of the eight-opcode execution frame. The preferred execution-frame flag is a 1-bit EF flag on the eighth opcode, while other determinable eight-opcode boundary indications may be used.

In operation, an execution engine fetches or receives opcodes, decodes a balance class for each opcode, determines a signed contribution from the balance class, executes opcode semantics, accumulates the signed contribution in the balance accumulator, and determines whether an execution-frame boundary has been reached. At the boundary of the eight-opcode frame, the execution engine compares the accumulated frame balance with zero. If the accumulated frame balance equals zero, the execution engine permits architectural or virtual-machine state associated with the frame to commit. If the accumulated frame balance is nonzero, the execution engine prevents commit and performs a non-commit response.

In some embodiments, instruction results within an execution frame are maintained as speculative state until the frame boundary. The speculative state may include shadow registers, a reorder buffer, a write buffer, a speculative memory buffer, a checkpointed register file, transactional state, a commit queue, or another temporary state-storage structure. When the accumulated frame balance equals zero, the speculative state is promoted to committed architectural state. When the accumulated frame balance is nonzero, the speculative state is discarded or reverted to a prior checkpoint. Superscalar or out-of-order execution may be used, provided that the execution engine preserves a defined eight-opcode frame membership and computes the signed frame balance associated with the frame before commit.

In some embodiments, a compatible compiler generates ledger-conformant code. The compiler may receive source code or intermediate representation operations, assign balance classes to operations, partition operations into eight-opcode execution frames, compute a signed balance for each candidate frame, and adjust the frame until the frame balance equals zero. The compiler may balance a frame by semantic-preserving reordering, inserting architecturally neutral compensating opcodes, inserting neutral padding opcodes, substituting equivalent instruction sequences, distributing operations across adjacent frames, selecting alternative instruction encodings having different balance classes, changing scheduling boundaries, using paired operations, or emitting a diagnostic when a frame cannot be balanced under a selected target policy. The compiler may then emit executable opcodes with frame-boundary indications and may generate frame attestation data.

In some embodiments, a compatible virtual machine executes ledger-conformant bytecode or opcode streams on non-native hardware. The virtual machine maintains a software balance accumulator, fetches and decodes opcodes, executes host-side semantics, accumulates signed opcode contributions, detects eight-opcode frame boundaries, and applies the same zero-balance commit rule. If the software balance accumulator equals zero at the frame boundary, the virtual machine commits VM state. If the software balance accumulator is nonzero, the virtual machine rolls back to a prior checkpoint or performs another non-commit response. In some embodiments, a just-in-time compiler emits host instructions grouped according to the same eight-opcode frame-balance rule.

In some embodiments, a ledger-conformant executable includes a ledger section or associated metadata containing an instruction-set architecture version, compiler identifier or compiler hash, static balance proof hash or other integrity value, number of execution frames, contribution map, and frame-level attestation table. A loader may read the ledger section or associated metadata, recompute or verify the integrity value, validate frame count or frame-boundary indications, and refuse execution when verification fails. The integrity value may be a proof hash, attestation hash, checksum, cryptographic digest, digital signature, Merkle root, certificate, or other verification value. SHA-256 is one preferred example of an integrity value.

In some embodiments, an executable format is an ELF-compatible container having a ledger section. In other embodiments, the ledger-conformant executable or associated metadata may be embodied as or associated with a PE executable, Mach-O executable, firmware image, boot image, bytecode module, WebAssembly-like module, containerized executable, secure enclave image, blockchain virtual-machine artifact, embedded-controller image, FPGA configuration package, or other executable or loadable artifact. The attestation data may be stored within the executable, adjacent to the executable, in a signed manifest, in a loader-accessible metadata block, or in a remote verification service.

In some embodiments, the architecture is implemented in a hardware processor. The hardware processor may include an instruction fetch unit, instruction decoder, primary opcode decoder, balance-class decoder, signed contribution lookup, execution-frame boundary detector, frame counter, balance accumulator, zero comparator, commit-control logic, rollback checkpoint storage, register file, memory interface, imbalance flag register, exception interface, and debug or audit interface. The hardware implementation may be an in-order processor, out-of-order processor, superscalar processor, microcoded engine, softcore processor, coprocessor, secure enclave module, FPGA implementation, ASIC implementation, or another hardware execution engine.

In some embodiments, the disclosed ledger-enforced architecture is supported by formal verification. The formal verification may include a patent-specific formalization of balance classes, opcode formats, execution frames, balance registers or accumulators, compiler balance passes, virtual-machine state, executable headers, and commit conditions. The formal verification may also include proofs or verification artifacts establishing that zero accumulated frame balance permits commit, that compiler-emitted frames are balanced, that a virtual machine applies an analogous boundary-neutrality rule, or that an eight-step boundary discipline is preserved. Formal verification supports optional verification-method embodiments and prosecution credibility, but use of a particular proof system is not required to practice the broad execution architecture unless expressly recited in a claim.

In some embodiments, the disclosed architecture is related to an eight-tick recognition ledger. The eight-tick relationship supplies a canonical eight-slot periodicity, while the machine-level implementation enforces algebraic frame neutrality. The instruction datapath need not compute complex phases. In the disclosed machine invariant, the signed sum across the eight-opcode execution frame must vanish before architectural or virtual-machine state is allowed to commit.

In some embodiments, an LNAL opcode family or another eight-operation semantic antecedent maps into the disclosed balance-class taxonomy. Such a mapping may provide formal or semantic correspondence to an eight-step boundary-neutrality discipline. The disclosed instruction-set architecture, however, need not be a byte-for-byte restatement of any antecedent instruction representation. A corresponding opcode family may provide a semantic antecedent, compatibility mapping, or formal verification anchor without limiting the concrete opcode format of the disclosed architecture.

The disclosed architecture may be used in non-limiting downstream environments including safety-critical processors, automotive systems, avionics systems, medical-device controllers, industrial controllers, blockchain execution engines, smart-contract virtual machines, artificial-intelligence inference accelerators, quantum error-correction controllers, secure enclave processors, hardware security modules, high-performance computing systems, edge devices, and Internet-of-things devices. These downstream embodiments use the ledger-enforced execution mechanism to improve execution integrity, frame-balance enforcement, tamper resistance, rollback behavior, or fault-detection granularity. These downstream environments do not redefine the core instruction-execution architecture.

The disclosed architecture provides several technical advantages. Because balance semantics are embedded in executable opcodes and enforced at a frame boundary, the architecture provides instruction-level ledger enforcement rather than merely after-the-fact error detection. Because state commitment is gated by a zero-balance frame condition, an imbalanced frame may be prevented from becoming committed architectural or virtual-machine state. Compatible compiler, executable-format, loader, processor, and virtual machine embodiments may share the same frame-balance rule to support hardware/software co-verification, executable attestation, cross-platform execution, and tamper-resistant deployment.

### BRIEF DESCRIPTION OF FIGURES

FIG. 1 is a block diagram of a ledger-enforced computing stack including a compiler, a ledger-conformant binary, a hardware execution engine, a virtual-machine execution engine, and a common eight-opcode frame-balance rule.

FIG. 2 is a diagram of a fixed-length opcode format including a primary opcode field, a balance-class field, an execution-frame flag, a destination-register field, and an immediate, source-register, or operand field.

FIG. 3 is a table-style diagram showing balance-class encoding and signed algebraic contributions associated with exemplary balance classes.

FIG. 4 is a diagram of an eight-opcode execution frame in which each opcode contributes a signed balance value that is accumulated into a frame balance accumulator and evaluated at a frame boundary.

FIG. 5 is a state diagram showing balance accumulation, zero comparison, speculative-state handling, commit, checkpoint update, rollback, trap, safe-state entry, and reset behavior.

FIG. 6 is a flow diagram of a compiler workflow including source-code processing, intermediate-representation generation, frame partitioning, balance-class assignment, frame-balance analysis, compensation, reordering, proof or attestation generation, and binary emission.

FIG. 7 is a diagram of a ledger-conformant executable format including executable sections, a ledger section or associated metadata, an integrity value, a frame-attestation table, and a loader verification protocol.

FIG. 8 is a flow diagram of a virtual-machine execution loop that enforces an eight-opcode frame-balance rule on non-native host hardware.

FIG. 9 is a hardware block diagram of an execution engine including instruction fetch, decode logic, balance-class decoding, signed-contribution lookup, frame-boundary detection, a balance accumulator, a zero comparator, commit-control logic, rollback checkpoint storage, and an exception path.

FIG. 10 is a correspondence diagram showing relationships between a patent-specific ledger-enforced ISA formalization and an LNAL antecedent formalization, including opcode format, execution-frame, balance-register, virtual-machine-state, winSum8, winIdx8, and boundary-neutrality components.

FIG. 11 is an application map showing non-limiting downstream embodiments including safety-critical processing, blockchain execution, artificial-intelligence inference, quantum error-correction control, secure-enclave processing, high-performance computing, and edge or Internet-of-things deployment.

FIG. 12 is a worked-example diagram showing a balanced execution frame, an imbalanced execution frame, and a compiler-corrected execution frame.

### DETAILED DESCRIPTION

The following detailed description describes embodiments of a ledger-enforced instruction-execution architecture. The disclosed architecture is centered on a frame-level commit discipline in which executable opcodes carry balance-class metadata, exactly eight opcodes form an execution frame, signed algebraic contributions associated with the opcodes are accumulated over the execution frame, and architectural or virtual-machine state is permitted to commit only when the accumulated frame balance equals zero at the frame boundary.

The disclosed architecture is not merely a passive error-detection mechanism. In disclosed embodiments, the accumulated frame balance operates as a commit gate. An imbalanced frame is prevented from becoming committed architectural or virtual-machine state. Accordingly, a nonzero accumulated frame balance may cause rollback, speculative-state discard, trapping, exception signaling, refusal of execution, safe-state entry, diagnostic logging, re-execution, or another non-commit response.

The core machine invariant may be expressed as:

frameLedgerSum(frame)=0

where frameLedgerSum(frame) is the signed sum of balance contributions associated with the exactly eight opcodes of an execution frame. The signed sum across the eight-opcode execution frame must vanish before architectural or virtual-machine state is allowed to commit. In embodiments related to an eight-tick recognition ledger, the canonical eight-slot periodicity may be expressed by the identity sum_{k=0}\hat{ }{7} exp(2pii*k/8)=0. The disclosed datapath need not compute this complex-phase expression during instruction execution. Instead, the ISA realizes the eight-slot periodicity as an exactly eight-opcode execution frame and enforces the induced algebraic invariant that the signed frame balance equals zero before commit.

The disclosed architecture is a frame-level architecture. It does not require that a single opcode decompose into eight micro-operations. Rather, each execution frame includes exactly eight opcodes, and the frame as a whole is evaluated against the zero-balance commit condition. The disclosed architecture also does not require complex-phase computation in the instruction datapath. References to an eight-step, eight-slot, eight-cycle, or micro-operation antecedent should be understood as describing a boundary-neutral execution discipline that is implemented in the present architecture at the opcode-frame level unless a narrower implementation is expressly recited. In some implementations, an opcode may internally execute through multiple micro-operations, pipeline stages, or microcoded steps, and one or more such internal steps may decode balance-class metadata, update a balance accumulator, or perform a boundary comparison. Such internal implementation details do not alter the core frame rule that the commit condition is evaluated over an execution frame containing exactly eight opcodes. Accordingly, the disclosed architecture preserves compatibility with eight-step antecedent descriptions while avoiding any requirement that every opcode itself decompose into exactly eight micro-operations. A Recognition Science eight-tick relationship may supply a canonical eight-slot periodicity, while the machine-level implementation enforces algebraic frame neutrality using signed balance contributions and a balance accumulator.

For clarity, the terms used in this description are given their ordinary meaning in computer architecture unless otherwise indicated. An “opcode” or “instruction” refers to an executable instruction word, bytecode word, microcode word, instruction representation, or other executable operation representation. A “balance-class field” refers to one or more bits, symbols, tags, metadata fields, decoded instruction properties, or other encoded information that identifies a signed algebraic contribution associated with an opcode. A “contribution map” refers to a mapping from balance classes to signed balance contributions. A “balance accumulator” refers to hardware, firmware, microcode, software, virtual-machine-level, or hybrid storage configured to accumulate signed balance contributions over an execution frame. In preferred hardware embodiments, the balance accumulator is a signed balance register.

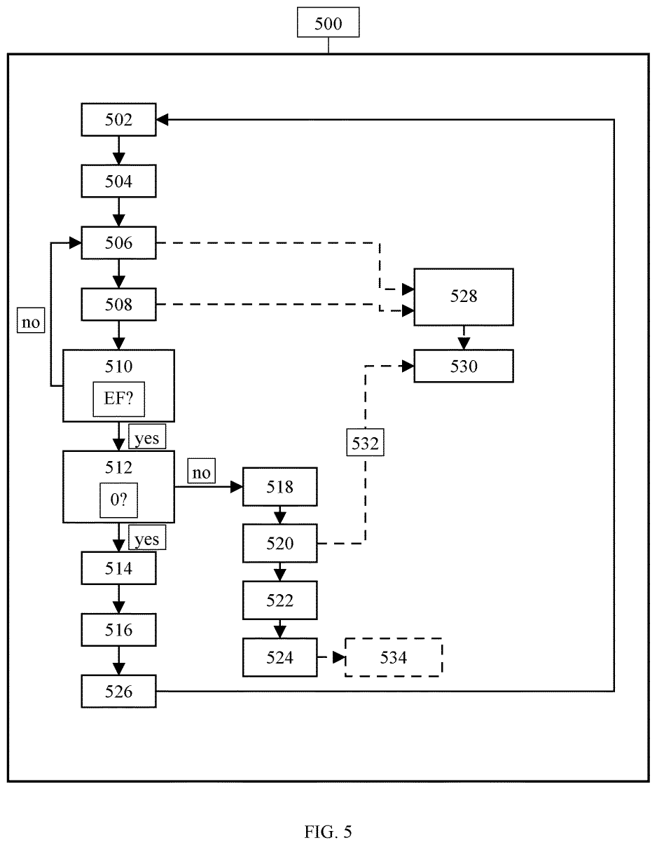

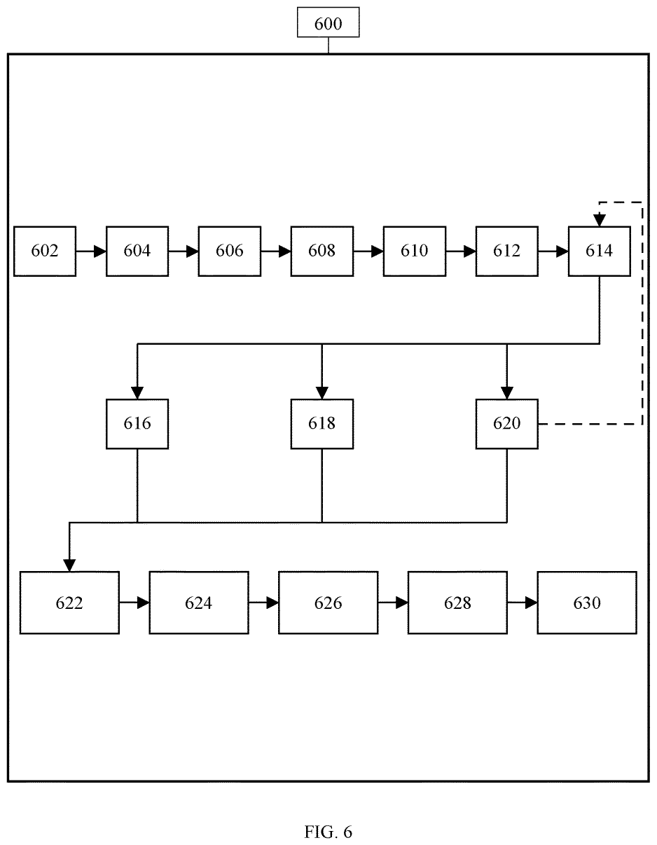

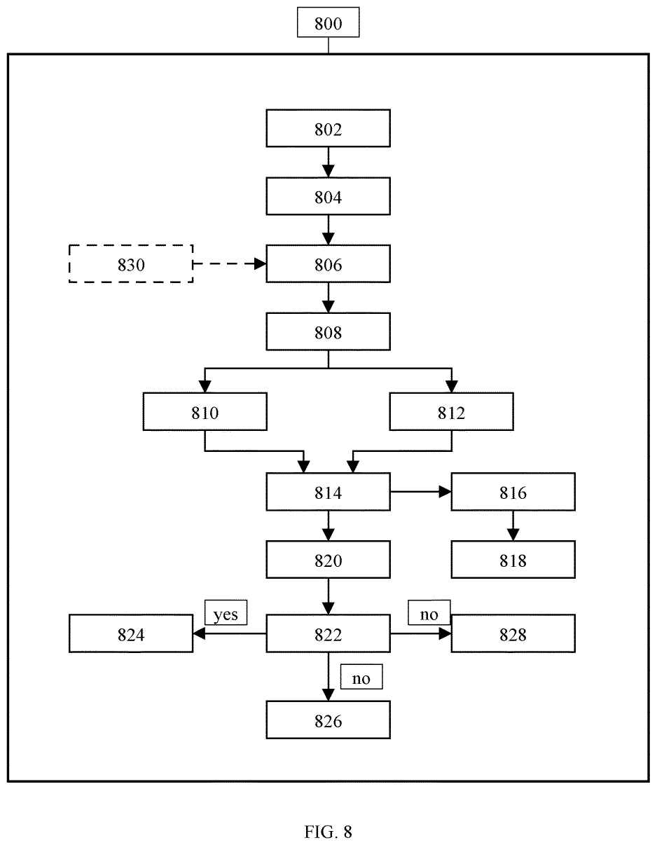

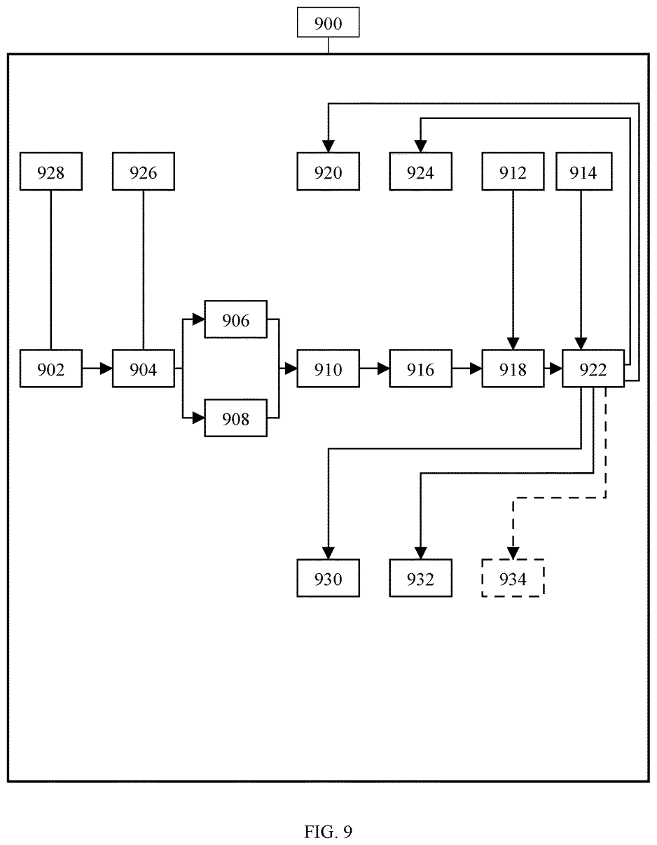

As used herein, a “module,” “detector,” or “logic” may be implemented as circuitry, and/or as one or more processors executing instructions stored in memory, and/or as firmware or microcode. Where a module, detector, or logic is described as being “configured to” perform an operation (including assigning balance classes, partitioning into frames, accumulating signed contributions, detecting frame boundaries, comparing to zero, and permitting or preventing commit), such operation may be implemented by executing the corresponding steps described with respect to FIG. 6 (compiler workflow), FIG. 8 (virtual-machine loop), and/or FIG. 5/FIG. 9 (commit-control and hardware execution), and equivalents thereof.

An “execution frame” refers to a bounded group of opcodes that is evaluated according to a frame-balance rule. In the core disclosed architecture, the execution frame includes exactly eight opcodes. A “frame-boundary indication” refers to an explicit or implicit indication that identifies completion of the eight-opcode execution frame. In preferred embodiments, the frame-boundary indication is a one-bit execution-frame flag, also referred to as an EF flag, set in the final opcode of the frame. In other embodiments, the frame-boundary indication may be provided by an implicit eight-slot frame counter, a reserved boundary opcode, instruction-prefix metadata, binary-frame metadata, VM bytecode metadata, microcode state, or another boundary indication.

In some embodiments, the reserved boundary opcode, ledger-operation opcode, or VM bytecode marker may be implemented as a LEDGER COMMIT type instruction, boundary instruction, balance-check instruction, or other ledger operation that identifies completion of an execution frame or triggers comparison of the accumulated frame balance. In such embodiments, the LEDGER COMMIT type instruction may occupy the final opcode position of an eight-opcode execution frame, may be represented by an execution-frame flag carried by the final opcode, or may be represented by associated executable metadata identifying the final opcode position. Thus, a disclosed frame boundary may be implemented by an explicit opcode, by an EF flag, by metadata, or by an implicit counter, provided that the execution engine can determine completion of the eight-opcode execution frame before permitting commit.

A “balanced frame” refers to an execution frame for which the accumulated signed frame balance equals zero at the frame boundary. A “non-commit response” refers to an action taken when an execution frame is not balanced at the frame boundary, including rollback, trap, exception signaling, speculative-state discard, process termination, frame quarantine, binary refusal, diagnostic logging, re-execution, or safe-state entry. A “ledger-conformant binary” refers to an executable, bytecode module, firmware image, VM artifact, or other executable artifact that includes or is associated with frame-balance information, balance-class information, boundary information, attestation information, or other metadata enabling enforcement or verification of the disclosed frame-balance rule.

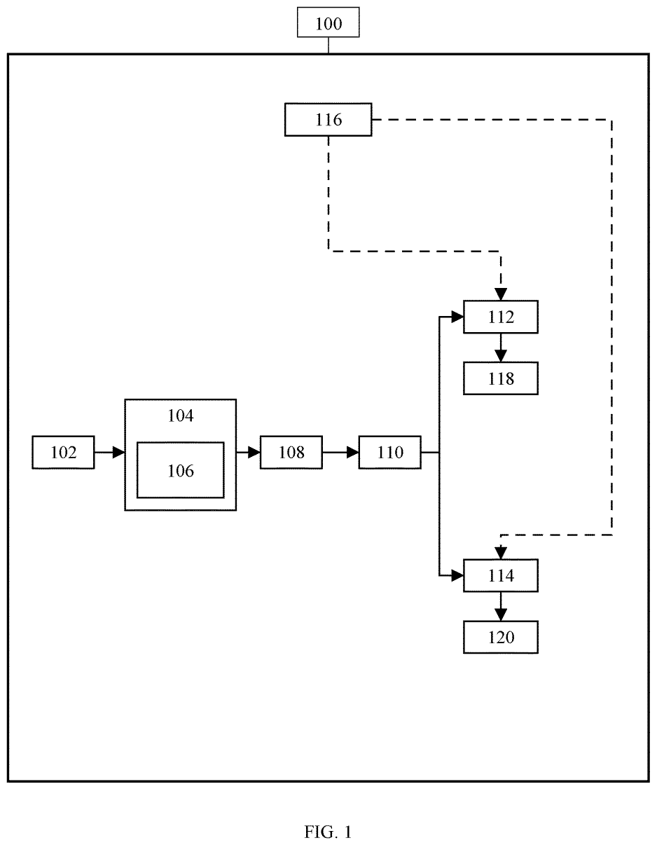

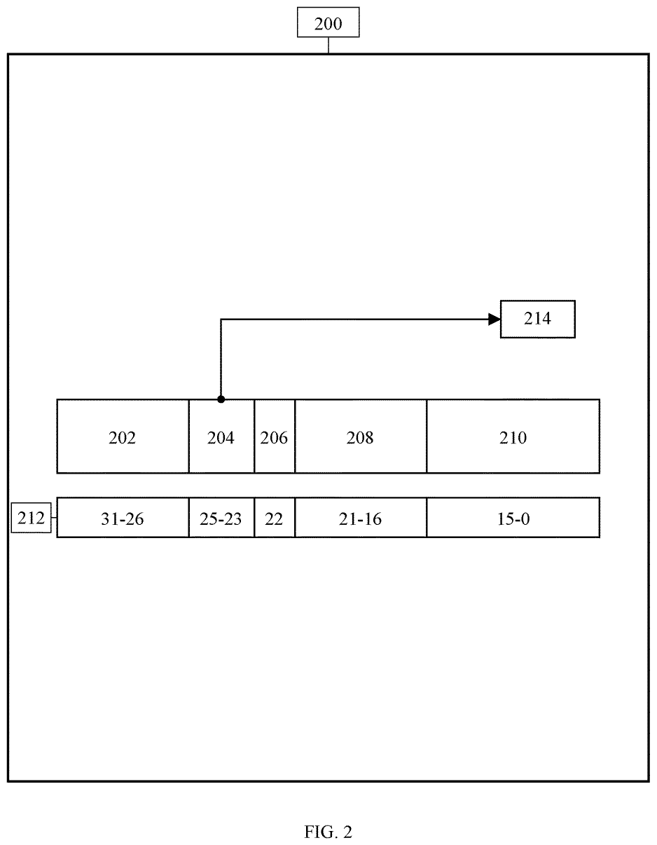

The following description refers to FIGS. 1-12. The drawings are schematic and are not necessarily drawn to scale. The same reference numeral series is used within each figure. For example, FIG. 1 uses reference numerals in the 100 series, FIG. 2 uses reference numerals in the 200 series, and so on. Features described with respect to one embodiment may be combined with features described with respect to another embodiment unless such combination is expressly inconsistent.

FIG. 1 depicts a ledger-enforced computing stack 100. The stack 100 illustrates how the disclosed frame-balance rule may be implemented across source-code processing, binary generation, hardware execution, virtual-machine execution, and commit or exception handling. Although FIG. 1 shows multiple components in a single stack, the disclosed invention does not require every implementation to include all illustrated components. For example, a hardware-only embodiment may enforce the frame-balance rule without a virtual machine, and a virtual-machine-only embodiment may enforce the frame-balance rule on non-native host hardware without a custom processor.

The ledger-enforced computing stack 100 receives source code or program input 102. The source code or program input 102 may include source code written in a high-level programming language, assembly code, intermediate representation code, bytecode, firmware instructions, smart-contract code, model-execution instructions, control software, or other program material to be compiled, translated, interpreted, verified, or executed.

A compiler 104 processes the source code or program input 102. In some embodiments, the compiler 104 includes a front end configured to parse the source code or program input 102, one or more intermediate-representation stages, optimization stages, register-allocation stages, scheduling stages, code-generation stages, and binary-emission stages. The compiler 104 may be a native compiler, cross-compiler, just-in-time compiler, ahead-of-time compiler, assembler, bytecode generator, firmware compiler, smart-contract compiler, or another translation tool.

The compiler 104 includes or cooperates with a compiler balance pass 106. The compiler balance pass 106 assigns balance classes to operations, partitions operations into execution frames of exactly eight opcodes, computes signed balance sums for candidate frames, and modifies the candidate frames until the frame-balance rule is satisfied. The compiler balance pass 106 may use semantic-preserving reordering, compensating opcodes, neutral padding opcodes, equivalent instruction substitutions, adjacent-frame scheduling, alternative encodings, paired operations, or other transformations to cause each emitted execution frame to satisfy the zero-balance condition.

The compiler 104 emits a ledger-conformant binary 108. The ledger-conformant binary 108 may be a native executable, bytecode module, firmware image, boot image, virtual-machine artifact, secure-enclave image, FPGA configuration package, or other executable artifact. The ledger-conformant binary 108 includes executable opcodes arranged into exactly eight-opcode execution frames. In preferred embodiments, the ledger-conformant binary 108 also includes ledger section or attestation data 110.

The ledger section or attestation data 110 may include an ISA version, compiler identifier, compiler hash, static balance proof hash, integrity value, number of execution frames, frame-boundary table, contribution map, frame-level attestation table, digital signature, Merkle root, certificate, checksum, cryptographic digest, or other verification information. Although some embodiments use an ELF-compatible ledger section, the ledger section or attestation data 110 may be stored in or associated with other executable formats, including PE, Mach-O, firmware, boot image, bytecode, WebAssembly-like module, containerized executable, secure enclave image, blockchain VM artifact, embedded controller image, or FPGA configuration formats.

The ledger-conformant binary 108 may be executed by a hardware execution engine 112. The hardware execution engine 112 may include instruction fetch logic, instruction decode logic, balance-class decode logic, an execution-frame boundary detector, a balance accumulator, a frame counter, a zero comparator, commit-control logic, rollback checkpoint storage, speculative-state storage, a register file, a memory interface, an exception path, and optional debug or audit interfaces. During execution, the hardware execution engine 112 accumulates signed contributions associated with opcodes in an execution frame and permits state commitment only when the accumulated frame balance equals zero at the frame boundary.

The ledger-conformant binary 108 or an equivalent bytecode representation may also be executed by a virtual-machine execution engine 114. The virtual-machine execution engine 114 may include a software interpreter, emulator, just-in-time compiler, sandbox runtime, bytecode engine, smart-contract VM, or other software execution environment. In such embodiments, the virtual-machine execution engine 114 maintains a software balance accumulator, decodes balance classes and frame-boundary indications, executes host-side instruction semantics, accumulates signed contributions, and applies the same zero-balance commit rule at each eight-opcode frame boundary.

The hardware execution engine 112 and the virtual-machine execution engine 114 may enforce a common eight-op frame-balance rule 116. The common eight-op frame-balance rule 116 requires that each execution frame include exactly eight opcodes and that the signed balance contributions associated with those opcodes sum to zero before state associated with the frame is committed. The common eight-op frame-balance rule 116 allows the compiler 104, hardware execution engine 112, virtual-machine execution engine 114, loader, verifier, or other tooling to share the same architectural invariant.

The output of execution may include commit/rollback output 118. The commit/rollback output 118 may indicate that a frame has committed, that speculative state has been promoted to committed state, that a rollback has occurred, that a checkpoint has been restored, or that an execution frame has been re-executed. The output may also include audit or exception output 120. The audit or exception output 120 may include an imbalance flag, exception code, trap record, frame identifier, balance value, failed attestation record, loader refusal event, safe-state indication, or other diagnostic output.

The architecture shown in FIG. 1 supports several independent implementation modes. In a hardware-only mode, a processor implements opcode decoding, balance accumulation, frame-boundary detection, zero comparison, and commit-control logic without requiring a virtual machine. In a VM-only mode, a software VM or interpreter enforces the same rule on non-native host hardware. In a compiler or product mode, a compiler generates ledger-conformant code, frame attestation data, or proof metadata for later execution. In an ecosystem mode, hardware, compiler, VM, executable format, and loader enforce a common frame-balance rule.

The stack 100 therefore illustrates multiple pathways for implementing the core eight-opcode zero-balance commit discipline without requiring every pathway in every embodiment.

FIG. 2 depicts an exemplary fixed-length opcode word 200. The opcode word 200 is one preferred encoding for carrying operation semantics and balance metadata in a ledger-enforced instruction-set architecture. The illustrated format is not limiting. Other fixed-length opcode widths, field orders, field sizes, operand arrangements, metadata encodings, or instruction representations may be used, provided that the executable operation representation carries or is associated with balance-class metadata and is evaluated under the disclosed eight-opcode frame-balance rule.

The opcode word 200 includes a primary opcode field 202. The primary opcode field 202 identifies the operation to be performed, such as an arithmetic operation, logical operation, memory operation, branch operation, ledger operation, control operation, system operation, synchronization operation, or other instruction operation. In a preferred 32-bit embodiment, the primary opcode field 202 may occupy six bits, such as bits 31 through 26. Other bit widths may be used.

The opcode word 200 includes a balance-class field 204. The balance-class field 204 identifies a balance class associated with the opcode word 200. The balance class is used to determine a signed algebraic contribution for the opcode word 200. In preferred embodiments, the balance-class field 204 is a 3-bit field. A 3-bit balance-class field may encode eight classes, such as ArithmeticAdd, ArithmeticSub, Logic, Memory, Branch, LedgerOps, Reserved, and Vendor classes. In other embodiments, the balance-class field 204 may include at least two bits, more than three bits, an extended class identifier, a compressed class identifier, an index into a contribution map, or another balance metadata representation.

The opcode word 200 includes an execution-frame flag 206. In preferred embodiments, the execution-frame flag 206 is a 1-bit EF flag that marks the final opcode of an eight-opcode execution frame. When the execution-frame flag 206 indicates that the opcode word 200 is the final opcode of the frame, the execution engine compares the accumulated frame balance with zero before committing architectural or virtual-machine state associated with the frame.

The execution-frame flag 206 is a preferred boundary-marker encoding. In other embodiments, a frame boundary may be indicated by an implicit eight-slot frame counter, a reserved boundary opcode, instruction-prefix metadata, binary-frame metadata, VM bytecode metadata, microcode state, or another boundary indication. Thus, the broader architecture requires a determinable eight-opcode frame boundary, but is not limited to a particular bit position or a particular EF-flag encoding unless such a limitation is expressly recited in a claim.

The opcode word 200 includes a destination-register field 208. The destination-register field 208 may identify a destination register, architectural register, virtual register, accumulator, memory destination, stack location, vector lane, special-purpose register, predicate register, or other destination for the operation identified by the primary opcode field 202. In a preferred 32-bit embodiment, the destination-register field 208 may occupy six bits, such as bits 21 through 16, thereby supporting up to 64 destination-register identifiers. Other register counts and field widths may be used.

The opcode word 200 includes an immediate or operand field 210. The immediate or operand field 210 may encode an immediate value, source-register identifier, memory offset, branch displacement, literal value, mode field, operand bundle, register-pair identifier, vector index, or other instruction operand. In a preferred 32-bit embodiment, the immediate or operand field 210 may occupy sixteen bits, such as bits 15 through 0. In other embodiments, the field may be extended, compressed, split into multiple source-register fields, interpreted according to the primary opcode field 202, or replaced by an operand-specifier format.

A bit-position legend 212 may identify the preferred field locations within the opcode word 200. For example, the bit-position legend 212 may show bits 31 through 26 for the primary opcode field 202, bits 25 through 23 for the balance-class field 204, bit 22 for the execution-frame flag 206, bits 21 through 16 for the destination-register field 208, and bits 15 through 0 for the immediate or operand field 210. These bit positions are preferred implementation details and do not limit the broader disclosure.

The balance-class field 204 produces or selects a signed contribution output 214. The signed contribution output 214 may be generated by a signed contribution lookup table, contribution-map decoder, hardwired decoder, microcode routine, software interpreter, VM decode step, or other balance-class decoding mechanism. In preferred embodiments, the signed contribution output 214 is +1 for a positive arithmetic class, −1 for a negative arithmetic class, and 0 for neutral classes. In alternative embodiments, the signed contribution output 214 may be a bounded signed integer, signed fixed-point value, weighted contribution, implementation-defined value, or value specified by an ISA profile or binary metadata.

During execution, the signed contribution output 214 is added to a balance accumulator associated with the current eight-opcode execution frame. The opcode word 200 may therefore perform two roles. First, the opcode word 200 specifies an executable operation through fields such as the primary opcode field 202, destination-register field 208, and immediate or operand field 210. Second, the opcode word 200 participates in the ledger-enforced commit discipline through the balance-class field 204 and the execution-frame flag 206 or other boundary indication.

In a preferred embodiment, each opcode word 200 is part of a sequence of exactly eight opcode words forming an execution frame. Seven opcode words may have the execution-frame flag 206 cleared, and the eighth opcode word may have the execution-frame flag 206 set. As the eight opcode words execute, the signed contribution output 214 from each opcode word is accumulated. When the eighth opcode word is reached, the execution-frame flag 206 causes the accumulated frame balance to be compared with zero. If the accumulated frame balance equals zero, state associated with the frame may commit. If the accumulated frame balance is nonzero, the execution engine prevents commit and performs a non-commit response.

The opcode format shown in FIG. 2 embeds or associates balance semantics with the executable instruction representation itself, allowing the balance-class field 204 to carry algebraic contribution information that is enforced at the frame boundary.

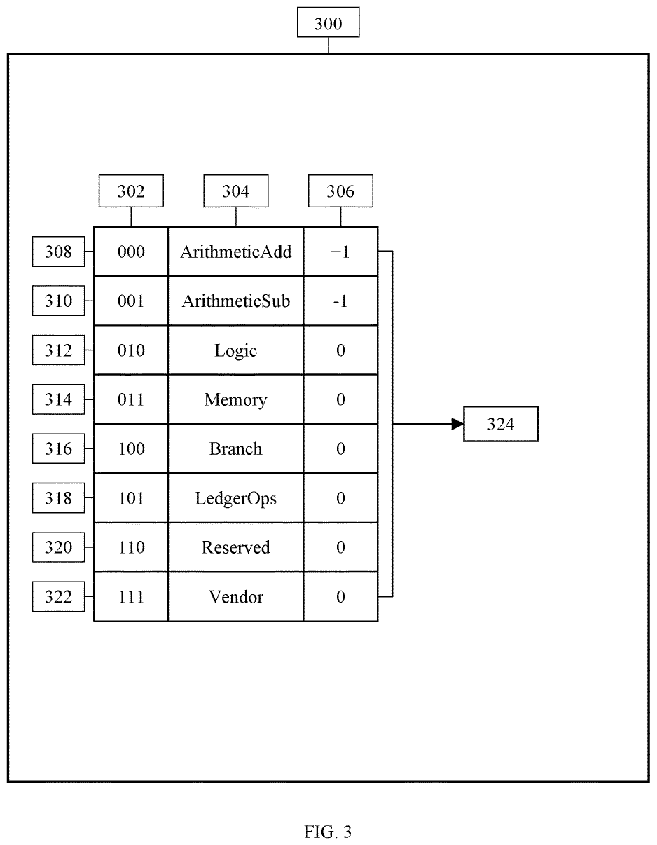

FIG. 3 depicts an exemplary balance-class taxonomy 300. The balance-class taxonomy 300 defines how balance-class metadata associated with an opcode is converted into a signed algebraic contribution for accumulation over an eight-opcode execution frame. The taxonomy shown in FIG. 3 is a preferred taxonomy. Other taxonomies may be used, provided that each opcode in an execution frame is associated with a signed contribution under a contribution map and the execution frame is evaluated against a zero-balance commit condition.

The balance-class taxonomy 300 includes a balance-class code column 302. The balance-class code column 302 identifies encoded values of a balance-class field, such as the balance-class field 204 of FIG. 2. In a preferred embodiment, the balance-class code column 302 includes 3-bit values. A 3-bit field provides eight possible encoded classes. In other embodiments, the balance-class code column 302 may include two-bit values, four-bit values, extended values, symbolic values, microcode values, metadata values, or indexes into a contribution map.

In some embodiments, the balance-class field is a 3-bit field whose encoded values correspond to the balance-class codes shown in FIG. 3. For example, code 000 may encode an ArithmeticAdd class associated with a +1 contribution under the contribution map; code 001 may encode an ArithmeticSub class associated with a −1 contribution; code 010 may encode a Logic class associated with a 0 contribution; code 011 may encode a Memory class associated with a 0 contribution; code 100 may encode a Branch class associated with a 0 contribution; code 101 may encode a LedgerOps class associated with a 0 contribution; code 110 may encode a Reserved class; and code 111 may encode a Vendor class. The foregoing code-to-class mapping is illustrative and may be varied by an ISA profile, provided that a decoder can determine the signed contribution for each opcode and enforce the zero-balance commit rule over each execution frame.

The balance-class taxonomy 300 includes a class-name column 304. The class-name column 304 identifies a functional, semantic, or architectural class associated with each balance-class code. The class name may correspond to an instruction family, an operation type, a ledger operation, a reserved extension class, a vendor-defined class, or another contribution category. The class name is used for explanation and implementation clarity. The load-bearing machine behavior is the signed contribution associated with the class under the applicable contribution map.

The balance-class taxonomy 300 includes a signed-contribution column 306. The signed-contribution column 306 identifies the signed algebraic contribution associated with each balance class. During execution, the signed contribution is added to a balance accumulator for the current execution frame. A frame is balanced when the signed contributions of the exactly eight opcodes in the frame sum to zero at the frame boundary.

In the preferred taxonomy 300, an ArithmeticAdd class 308 has a positive signed contribution. In one embodiment, the ArithmeticAdd class 308 contributes +1 to the frame balance. The ArithmeticAdd class 308 may be assigned to addition operations, increment operations, accumulation operations, positive arithmetic updates, or other instructions selected by the ISA profile as having a positive ledger contribution.

An ArithmeticSub class 310 has a negative signed contribution. In one embodiment, the ArithmeticSub class 310 contributes −1 to the frame balance. The ArithmeticSub class 310 may be assigned to subtraction operations, decrement operations, inverse arithmetic updates, compensating operations, or other instructions selected by the ISA profile as having a negative ledger contribution.

A Logic class 312 has a neutral contribution in the preferred taxonomy. In one embodiment, the Logic class 312 contributes 0 to the frame balance. The Logic class 312 may be assigned to AND, OR, XOR, NOT, compare, bit-test, mask, predicate, or other logical operations. A neutral logic class permits logical operations to occupy frame slots without changing the signed balance of the frame.

A Memory class 314 has a neutral contribution in the current preferred formal core. In one embodiment, the Memory class 314 contributes 0 to the frame balance. The Memory class 314 may be assigned to load, store, prefetch, cache, address-generation, memory-barrier, or memory-synchronization operations. In alternative embodiments, memory operations may have nonzero contributions under a declared contribution map, provided that the frame as a whole satisfies the zero-balance commit condition.

A Branch class 316 has a neutral contribution in the current preferred formal core. In one embodiment, the Branch class 316 contributes 0 to the frame balance. The Branch class 316 may be assigned to conditional branches, unconditional branches, calls, returns, jumps, indirect branches, predication operations, or control-flow instructions. In alternative embodiments, branch or control-flow operations may have positive, negative, or implementation-defined signed contributions, provided that the execution-frame balance is still evaluated against zero at the frame boundary.

A LedgerOps class 318 has a neutral contribution in the preferred taxonomy. In one embodiment, the LedgerOps class 318 contributes 0 to the frame balance. The LedgerOps class 318 may be assigned to instructions that manipulate, inspect, reset, snapshot, audit, attest, or otherwise interact with ledger-enforcement state. In some embodiments, ledger-operation instructions are privileged instructions, debug instructions, VM instructions, microcode instructions, or system-level instructions. In other embodiments, one or more ledger-operation instructions may carry nonzero contributions if specified by the applicable contribution map.

A Reserved class 320 may be used for future extension. In one embodiment, the Reserved class 320 contributes 0 unless an ISA profile assigns another contribution. A reserved class allows later instruction families, extension sets, coprocessor operations, vector operations, tensor operations, security operations, or other functions to be introduced without departing from the frame-balance architecture.

A Vendor class 322 may be used for vendor-defined extension. In one embodiment, the Vendor class 322 contributes 0 unless a vendor-defined contribution map assigns another signed contribution. A vendor-defined class may be useful for specialized accelerators, secure processors, AI inference engines, blockchain execution engines, embedded controllers, FPGA softcores, or application-specific instruction extensions. Vendor-defined classes remain subject to the zero-balance commit condition for each eight-opcode execution frame.

The balance-class taxonomy 300 produces a contribution-map output 324. The contribution-map output 324 represents the signed value that is supplied to the balance accumulator for an opcode of the corresponding balance class. The contribution-map output 324 may be generated by combinational decode logic, a lookup table, microcode, firmware, VM interpreter logic, JIT-generated host instructions, compiler metadata, or binary attestation metadata.

The contribution map associated with the balance-class taxonomy 300 may be fixed by the ISA, declared by an ISA profile, embedded in an executable metadata section, verified by a loader, or hardwired into processor logic. In a preferred embodiment, the contribution map assigns +1, −1, and 0 to positive, negative, and neutral classes, respectively. In alternative embodiments, the contribution map may assign bounded signed integer values, signed fixed-point values, multiple positive contribution levels, multiple negative contribution levels, or implementation-defined values. Such alternative contribution maps remain within the disclosed architecture if an execution frame is accepted for commit only when the accumulated frame balance satisfies the zero-balance condition.

The taxonomy 300 allows an instruction stream to carry both ordinary operation semantics and ledger-enforcement semantics. The primary opcode may specify what the instruction does, while the balance class specifies how that instruction contributes to the frame-level ledger. This separation allows a compiler, verifier, VM, or hardware decoder to reason about balance independently from the full functional semantics of each instruction, while still enforcing the zero-balance commit condition at the architectural boundary.

The balance-class taxonomy 300 also supports compiler-side frame construction. A compiler may select among opcodes having different balance classes, insert compensating or neutral opcodes, or reorder operations so that the signed contributions across an eight-opcode execution frame sum to zero before binary emission.

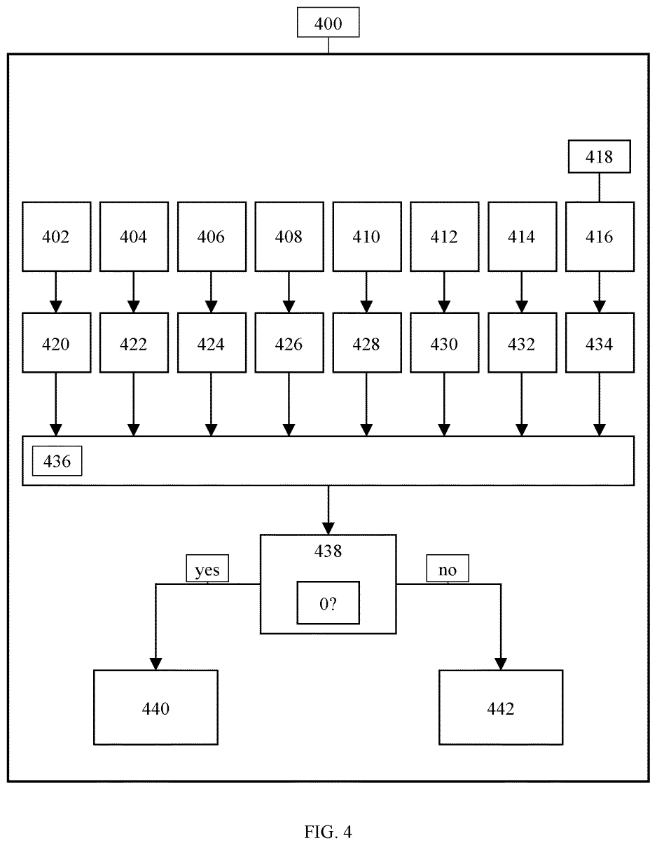

FIG. 4 depicts an eight-opcode execution frame 400. The execution frame 400 is the central frame-level structure of the disclosed ledger-enforced architecture. In the core architecture, exactly eight opcodes form one execution frame. The eight-opcode structure is not merely a scheduling preference or arbitrary batching strategy. Rather, the disclosed architecture uses the eight-opcode frame as the bounded unit over which signed balance contributions are accumulated and evaluated before state commitment.

The execution frame 400 includes a slot 0 opcode 402, a slot 1 opcode 404, a slot 2 opcode 406, a slot 3 opcode 408, a slot 4 opcode 410, a slot 5 opcode 412, a slot 6 opcode 414, and a slot 7 opcode 416. The slot numbers identify frame positions within the eight-opcode frame. Slot numbering may begin at zero as shown, or may be represented as first through eighth slots in another implementation. In either case, the frame includes exactly eight opcode positions.

The slot 7 opcode 416 includes or is associated with an EF flag 418 in the preferred embodiment. The EF flag 418 identifies the final opcode of the execution frame 400. When the EF flag 418 is detected, the execution engine treats the current opcode as the boundary of the eight-opcode execution frame 400 and triggers evaluation of the accumulated frame balance. In alternative embodiments, the boundary corresponding to the slot 7 opcode 416 may be identified by an implicit frame counter, metadata table, reserved boundary opcode, prefix, VM bytecode marker, or microcode state rather than by an explicit EF flag.

Each opcode in the execution frame 400 has an associated signed contribution. The slot 0 opcode 402 has contribution c0 420. The slot 1 opcode 404 has contribution c1 422. The slot 2 opcode 406 has contribution c2 424. The slot 3 opcode 408 has contribution c3 426. The slot 4 opcode 410 has contribution c4 428. The slot 5 opcode 412 has contribution c5 430. The slot 6 opcode 414 has contribution c6 432. The slot 7 opcode 416 has contribution c7 434. Each contribution may be determined by decoding the balance-class field of the corresponding opcode and applying a contribution map.

The contributions 420 through 434 are accumulated along a balance-register accumulation path 436. Although FIG. 4 refers to a balance-register accumulation path 436, the accumulation may be performed by any balance accumulator. In hardware embodiments, the balance accumulator may be a signed register. In VM embodiments, the balance accumulator may be a software value.

In microcode or firmware embodiments, the balance accumulator may be a microarchitectural or firmware-maintained value. In all such embodiments, the accumulator represents the signed frame balance over the eight-opcode execution frame 400.

The frame balance may be computed as:

frameLedgerSum(frame)=c0+c1+c2+c3+c4+c5+c6+c7

The execution frame 400 is balanced if and only if:

frameLedgerSum(frame)=0

The zero comparison 438 evaluates whether the accumulated frame balance equals zero at the frame boundary. If the zero comparison 438 determines that the accumulated frame balance equals zero, the execution engine follows a commit path 440. Along the commit path 440, architectural state, VM state, speculative state, memory effects, register effects, or other frame-associated state may be promoted to committed state according to the implementation.

If the zero comparison 438 determines that the accumulated frame balance is nonzero, the execution engine follows a rollback path 442 or another non-commit response. The rollback path 442 may restore state to a prior checkpoint, discard speculative state, raise an imbalance flag, trap to software, refuse execution, re-execute the frame, log diagnostic information, enter a safe state, or perform another non-commit response.

The execution frame 400 is distinct from conventional instruction grouping. Conventional instruction grouping may group instructions for cache lines, decode blocks, fetch bundles, vector lanes, branch prediction, scheduling windows, transaction boundaries, or pipeline efficiency. The execution frame 400, by contrast, is a commit-gating ledger frame. The signed contributions of the opcodes in the frame must satisfy the zero-balance rule before state is allowed to commit. This makes the frame an architectural or VM-level enforcement boundary, not merely a performance-oriented grouping.

In some embodiments, the execution engine resets the balance accumulator at the start of the execution frame 400. As each opcode in slots 402 through 416 executes, the corresponding contribution 420 through 434 is added to the balance accumulator. When the frame boundary is reached, the zero comparison 438 is performed. After a successful commit, the balance accumulator may be reset for the next frame. After an unsuccessful comparison, the balance accumulator may be reset, preserved for diagnostic logging, or restored according to a recovery policy.

In some embodiments, the execution frame 400 is created statically by a compiler. The compiler may assign balance classes, schedule operations into exactly eight slots, insert compensating or neutral operations, and place the EF flag 418 on the final opcode. In other embodiments, a VM, loader, microcode layer, or runtime scheduler may verify, interpret, or enforce the same frame discipline.

The eight-opcode execution frame 400 may be related to an eight-tick ledger cadence. In such embodiments, the eight-slot periodicity is realized at the machine level as exactly eight opcode positions. The implemented machine invariant remains algebraic frame neutrality, not complex-phase computation in the datapath. Thus, the execution engine need only accumulate signed contributions and perform the zero comparison 438.

The execution frame 400 provides a clear unit for static verification, runtime enforcement, rollback, attestation, and auditing across compiler, loader, hardware, VM, and audit embodiments.

FIG. 5 depicts a commit-control state machine 500. The commit-control state machine 500 illustrates one example of how an execution engine may enforce the zero-balance commit rule for an eight-opcode execution frame. The state machine 500 may be implemented in hardware, firmware, microcode, a VM interpreter, a JIT runtime, a simulator, a secure enclave, or another execution environment.

The state machine 500 begins at a frame-start state 502. The frame-start state 502 indicates that a new eight-opcode execution frame is beginning. The frame-start state 502 may be entered after a prior frame has committed, after a prior frame has been rolled back, after a trap or exception handler resumes execution, after a loader initializes execution, after a VM checkpoint is restored, or after a processor reset or context switch.

At a balance-register reset state 504, the balance accumulator is initialized for the new frame. In a preferred hardware embodiment, the balance accumulator is a balance register that is cleared to zero. In a VM embodiment, a software balance accumulator may be assigned a zero value. In some diagnostic embodiments, a prior value may be copied to a log before reset. In other embodiments, reset may include clearing a frame counter, clearing an EF-detected latch, initializing speculative-state tracking, or preparing a checkpoint.

The state machine 500 proceeds to an opcode execution state 506. In the opcode execution state 506, the execution engine fetches or receives an opcode, decodes the primary opcode, decodes the balance class, determines a signed contribution, and executes the opcode semantics.

Execution may include arithmetic, logic, memory access, branch evaluation, ledger operation, system operation, VM operation, or another instruction behavior. The opcode execution state 506 may be repeated for each opcode in the eight-opcode execution frame.

At a contribution accumulation state 508, the signed contribution associated with the executed opcode is added to the balance accumulator. The contribution may be generated by a contribution map, balance-class decoder, signed contribution lookup, VM decode table, microcode routine, or compiler-provided metadata. In a preferred +1, −1, 0 contribution map, the accumulation may increment, decrement, or leave unchanged the balance accumulator. In alternative embodiments, the accumulation may add other bounded signed values.

At an EF detection state 510, the execution engine determines whether the current opcode corresponds to the boundary of the execution frame. In a preferred embodiment, the EF detection state 510 detects an EF flag in the opcode. In other embodiments, the EF detection state 510 may detect that an implicit frame counter has reached the eighth slot, that a reserved boundary opcode has been encountered, that a metadata table identifies the current opcode as the final slot, or that another frame-boundary indication is present.

If the execution frame has not reached its boundary, the state machine 500 may return to opcode execution state 506 for the next opcode in the frame. If the frame boundary has been reached, the state machine 500 proceeds to a zero-compare state 512. At the zero-compare state 512, the accumulated frame balance is compared with zero. The comparison may be performed by a hardware zero comparator, VM comparison instruction, microcode branch, firmware routine, software conditional, or another comparison mechanism.

If the accumulated frame balance equals zero, the state machine 500 proceeds to a commit state 514. In the commit state 514, state associated with the frame is permitted to become committed state. The committed state may include register values, memory updates, program counter updates, status flags, VM state, microarchitectural state, or other state affected by the frame. In some embodiments, memory effects are buffered until commit. In other embodiments, memory effects may be reversible, checkpointed, or controlled by a store buffer until the zero-balance condition is satisfied.

After commit state 514, the state machine 500 may proceed to a checkpoint update state 516. In the checkpoint update state 516, the committed state becomes the new rollback checkpoint. The checkpoint may include a copy of architectural registers, VM state, memory pointers, program counter, frame counter, status registers, or other recovery data. In some embodiments, checkpoint update state 516 also updates audit logs, increments a committed-frame counter, clears an imbalance flag, or records a proof-of-execution event.

If the accumulated frame balance is nonzero at the zero-compare state 512, the state machine 500 proceeds to a nonzero imbalance state 518. The nonzero imbalance state 518 indicates that the eight-opcode execution frame failed the frame-balance rule. The failure may arise from transient hardware error, instruction tampering, illegal binary modification, compiler error, VM corruption, fault injection, memory corruption, branch misalignment, invalid EF placement, contribution-map mismatch, or another imbalance source.

From the nonzero imbalance state 518, the state machine 500 may proceed to a rollback state 520. In the rollback state 520, the execution engine restores architectural or VM state to a prior checkpoint. Rollback may include restoring register values, restoring a program counter, clearing speculative memory writes, restoring VM stack state, invalidating a store buffer, reverting status flags, resetting the frame counter, or discarding effects of the imbalanced frame.

The state machine 500 may also proceed to an IMB flag or exception state 522. In the IMB flag or exception state 522, the execution engine sets an imbalance flag, raises an exception, traps to software, signals a hypervisor, reports an error to a secure monitor, records a diagnostic event, or notifies a loader, operating system, runtime, or VM controller. In some embodiments, the imbalance flag indicates that the most recent frame failed the zero-balance commit condition.

The state machine 500 may proceed to a re-execute or trap branch 524. In one policy, the frame is re-executed after rollback. In another policy, execution traps to a handler. In another policy, execution is terminated or refused. In another policy, the executable image is quarantined. In another policy, the frame is logged for audit and the system enters a safe state. The selected policy may depend on an ISA profile, privilege level, VM policy, safety certification mode, security mode, application type, or loader configuration.

After a successful commit and checkpoint update, the state machine 500 may follow a next-frame branch 526. The next-frame branch 526 returns execution to the frame-start state 502 for a next eight-opcode execution frame. The next-frame branch 526 may also increment a frame counter, update a frame attestation pointer, advance a VM instruction pointer, or fetch the next instruction bundle.

The state machine 500 may include a speculative state buffer 528. The speculative state buffer 528 may hold state generated during execution of the current frame before that state is committed. The speculative state buffer 528 may include shadow registers, a reorder buffer, store queue, write buffer, speculative memory buffer, transactional state, VM checkpoint state, microarchitectural buffer, or another temporary state-storage structure.

The state machine 500 may include a commit queue 530. The commit queue 530 may hold completed frame results that are waiting for the zero comparison 512 or waiting to be promoted to committed state. In an out-of-order or superscalar implementation, individual opcodes may complete internally before the frame as a whole is allowed to commit. The commit queue 530 allows the execution engine to preserve frame-level commit discipline even when instruction execution is internally parallel, speculative, or out of program order.

If an imbalance is detected, the state machine 500 may follow a discard speculative state path 532. Along the discard speculative state path 532, the execution engine discards or invalidates state held in the speculative state buffer 528 or commit queue 530. This prevents effects of an imbalanced frame from becoming committed architectural or VM state.

The state machine 500 may also follow a safe-state path 534. The safe-state path 534 may place the processor, VM, secure enclave, controller, or system into a defined safe state. The safe-state path 534 may be useful in safety-critical, secure, industrial, medical, avionics, automotive, or embedded applications. Safe-state entry is an optional non-commit response and does not redefine the core invention.

The state machine 500 is illustrative. Other implementations may merge, split, pipeline, or otherwise implement the illustrated states in hardware, firmware, microcode, or VM interpreter logic, provided that signed contributions are accumulated over an exactly eight-opcode execution frame and state associated with the frame is permitted to commit only when the accumulated balance equals zero.

FIG. 6 depicts a compiler workflow 600 for generating ledger-conformant code. The compiler workflow 600 may be implemented by a native compiler, cross-compiler, ahead-of-time compiler, just-in-time compiler, assembler, bytecode generator, firmware compiler, smart-contract compiler, intermediate-representation optimizer, or other code-generation tool. The compiler workflow 600 is configured to produce executable opcodes organized into exactly eight-opcode execution frames that satisfy the zero-balance commit condition.

The compiler workflow 600 receives source code input 602. The source code input 602 may include high-level source code, assembly code, intermediate-representation code, bytecode, firmware source, smart-contract source, model-execution code, control software, or another program representation. The source code input 602 may be received as a file, stream, module, package, build artifact, library, function, kernel, contract, firmware routine, or other program unit.

A front-end parser 604 processes the source code input 602. The front-end parser 604 may perform lexical analysis, syntax analysis, semantic analysis, type checking, macro expansion, template expansion, module resolution, symbol-table generation, or other front-end processing. In some embodiments, the front-end parser 604 is part of a conventional compiler front end and is not itself required to be ledger-specific.

The front-end parser 604 produces an intermediate representation 606. The intermediate representation 606 may be a static single assignment representation, control-flow graph, data-flow graph, bytecode-like representation, machine-independent IR, machine-specific IR, microcode IR, low-level IR, high-level IR, or another representation suitable for analysis and code generation. The intermediate representation 606 may include operations, operands, dependencies, control-flow edges, memory effects, side-effect information, register constraints, scheduling constraints, and metadata.

A balance-class assignment module 608 assigns balance classes to operations in the intermediate representation 606 or to candidate opcodes derived from the intermediate representation 606. The balance-class assignment module 608 may use operation semantics, opcode tables, target ISA profiles, compiler annotations, type information, instruction-selection rules, or contribution-map metadata to assign a balance class to each operation. For example, an addition-like operation may be assigned a positive class, a subtraction-like operation may be assigned a negative class, and a logic operation may be assigned a neutral class. In other embodiments, memory, branch, synchronization, system, vector, tensor, security, or vendor-defined operations may be assigned neutral or nonzero classes according to a declared contribution map.

A frame partitioner 610 partitions operations or candidate opcodes into execution frames. In the core architecture, each execution frame includes exactly eight opcode slots. The frame partitioner 610 may begin with basic blocks, trace regions, scheduling regions, straight-line code segments, loop bodies, VM instruction sequences, microcode blocks, transaction-like regions, or other code regions. The frame partitioner 610 may preserve control-flow and data-dependency constraints while constructing candidate eight-opcode frames.

A frame-sum calculator 612 computes the signed balance of each candidate execution frame. The frame-sum calculator 612 applies the applicable contribution map to the balance class assigned to each opcode or operation in the candidate frame. The frame-sum calculator 612 may compute a value such as:

frameLedgerSum(frame)=c0+c1+c2+c3+c4+c5+c6+c7

where c0 through c7 are signed contributions associated with the eight frame slots. If the frame sum equals zero, the frame is balanced. If the frame sum is nonzero, the compiler workflow 600 modifies the candidate frame or reports a diagnostic according to a selected target policy.

A dependency checker 614 checks whether candidate modifications preserve program semantics. The dependency checker 614 may analyze register dependencies, memory dependencies, control dependencies, aliasing constraints, side-effect ordering, volatile operations, exception behavior, branch targets, synchronization constraints, privilege boundaries, instruction latencies, pipeline hazards, and other ordering or semantic constraints. The dependency checker 614 may prevent an operation from being moved, substituted, paired, or padded in a way that changes the intended behavior of the program.

An operation reordering module 616 may reorder operations within a candidate frame or across adjacent frames. The operation reordering module 616 may use dependency information from the dependency checker 614 to perform semantic-preserving reordering. In some embodiments, the operation reordering module 616 first attempts local reordering within a basic block. In other embodiments, the operation reordering module 616 may move operations across adjacent frame boundaries, split a block into multiple frames, or merge operations from adjacent scheduling regions, provided that data and control dependencies are preserved.

A compensating opcode insertion module 618 may insert one or more compensating opcodes. A compensating opcode may carry a signed contribution selected to reduce or eliminate a nonzero frame balance. In preferred embodiments, a compensating opcode has an architecturally neutral effect on program-visible state while contributing a positive or negative balance value. For example, a frame with excess positive contribution may receive one or more negative compensating opcodes. A frame with excess negative contribution may receive one or more positive compensating opcodes. In other embodiments, a compensating opcode may be a semantically paired operation, ledger operation, no-op-like operation, reversible operation, or target-specific instruction selected by the compiler.

A neutral padding module 620 may insert neutral padding opcodes into unused frame slots. A neutral padding opcode may contribute zero to the frame balance. The neutral padding module 620 may be used when a code region contains fewer than eight operations, when a frame has been balanced but not filled, or when instruction alignment, scheduling, timing, or attestation rules require an exactly eight-opcode frame. A neutral padding opcode may be a NOP, logic no-op, register move to the same register, predicate-safe instruction, VM no-op, microcode no-op, or other neutral operation defined by the ISA profile.

An EF flag setting module 622 sets an execution-frame flag or other frame-boundary indication for the final opcode or final slot of each execution frame. In a preferred embodiment, the EF flag setting module 622 sets a 1-bit EF flag on the eighth opcode of the frame. In other embodiments, the EF flag setting module 622 may generate a frame-boundary table, insert a reserved boundary opcode, emit prefix metadata, update a VM bytecode marker, or generate another boundary indication identifying the completion of each eight-opcode execution frame.

A static balance solver 624 verifies that each emitted execution frame satisfies the zero-balance condition. The static balance solver 624 may recompute the signed frame balance after all reordering, compensation, padding, substitution, and scheduling steps. The static balance solver 624 may also verify that each frame includes exactly eight opcodes, that each frame has a valid boundary indication, that branch targets preserve frame discipline, that exception edges and fall-through paths are valid, that contribution maps match the target profile, and that no emitted frame violates the selected ledger-enforcement policy.

A proof hash generator 626 generates proof, attestation, or integrity data. The proof hash generator 626 may compute a proof hash, attestation hash, checksum, cryptographic digest, digital signature, Merkle root, certificate, or other integrity value over a frame-attestation table, contribution map, frame-boundary table, compiler proof object, or other ledger-conformance data. In a preferred embodiment, the proof hash generator 626 computes a SHA-256 hash over a static balance proof or frame-attestation table and embeds the hash in a binary header or ledger metadata section. SHA-256 is one preferred integrity mechanism, but the disclosed compiler workflow is not limited to SHA-256.

A binary emitter 628 emits ledger-conformant code output 630. The ledger-conformant code output 630 may include machine code, bytecode, VM code, firmware, microcode, a secure enclave image, an FPGA configuration package, a smart-contract artifact, or another executable representation. The ledger-conformant code output 630 includes opcodes organized into exactly eight-opcode execution frames and may include frame-boundary indications, ledger metadata, proof hashes, attestation tables, contribution-map data, version data, or loader-readable metadata.

In some embodiments, the compiler workflow 600 applies a balancing decision sequence. The compiler may first attempt semantic-preserving local reordering. If local reordering is insufficient, the compiler may fill unused slots with existing neutral operations. If the frame remains imbalanced, the compiler may insert architecturally neutral compensating opcodes. If that is insufficient or inefficient, the compiler may substitute equivalent instruction sequences having different balance contributions, distribute operations across adjacent frames, change scheduling boundaries, or use paired operations. If the selected target policy cannot balance a frame without changing semantics, the compiler may report a diagnostic, reject compilation, emit a trap-safe frame, or request a different target policy.

The compiler workflow 600 may produce several output products. These may include a ledger-conformant executable, frame-attestation data, a static balance proof, a proof hash, a frame-boundary table, a contribution-map declaration, a compiler audit report, debug metadata, or a loader-verifiable manifest. Such output products may be stored in an executable, stored adjacent to an executable, supplied to a loader, supplied to a VM, supplied to hardware, or stored in a remote verification service.

The compiler workflow 600 shows how ordinary source or intermediate code can be transformed into executable frames that satisfy the eight-opcode zero-balance rule. In preferred embodiments, the compiler statically verifies before binary emission that every emitted execution frame has a signed frame balance equal to zero. In preferred embodiments, ledger conformity is established both statically by the compiler and dynamically by the execution engine.

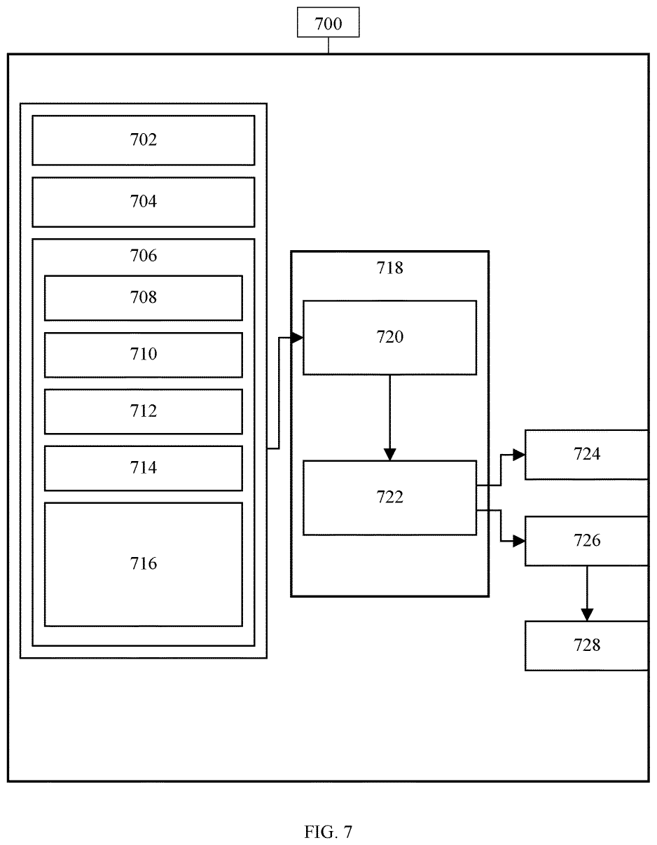

FIG. 7 depicts a ledger-conformant executable 700 and a loader verification protocol. The ledger-conformant executable 700 is an executable or loadable artifact that contains or is associated with code organized according to the disclosed eight-opcode frame-balance rule. The ledger-conformant executable 700 may be produced by the compiler workflow 600 of FIG. 6 or by another assembler, linker, VM toolchain, firmware-generation tool, smart-contract compiler, binary translator, or attestation service.

The ledger-conformant executable 700 may include a text section 702. The text section 702 may contain executable opcodes, bytecodes, firmware instructions, microcode, VM instructions, or another executable instruction representation. In preferred embodiments, the text section 702 contains opcodes arranged into exactly eight-opcode execution frames. Each opcode carries or is associated with balance-class metadata. Each frame includes a frame-boundary indication, such as an EF flag on the final opcode or metadata identifying the final frame slot.

The ledger-conformant executable 700 may include a data section 704. The data section 704 may contain constants, initialized data, relocation information, tables, literals, configuration data, jump tables, VM constants, model parameters, firmware data, or other non-instruction data. The data section 704 is shown for completeness and may be implemented according to the executable format used by the system.

The ledger-conformant executable 700 includes or is associated with a ledger section 706. The ledger section 706 contains metadata supporting verification, loading, attestation, enforcement, or audit of the eight-opcode frame-balance rule. In an ELF-compatible preferred embodiment, the ledger section 706 may be a custom section, such as an .rs_ledger section. In other embodiments, the ledger section 706 may be an associated manifest, metadata block, signed certificate, loader-accessible table, remote verification record, VM module section, firmware descriptor, or other ledger-conformance metadata.

The ledger section 706 may include an ISA version field 708. The ISA version field 708 may identify the ledger-enforced ISA version, contribution-map version, opcode layout version, VM bytecode version, target profile, extension set, vendor profile, or compatibility level. The ISA version field 708 allows a loader, VM, hardware execution engine, verifier, or audit tool to determine whether it can interpret the balance-class metadata and frame-boundary indications in the executable.

The ledger section 706 may include a compiler hash field 710. The compiler hash field 710 may identify the compiler, assembler, code generator, balance pass, toolchain, build version, source-control commit, compiler configuration, or verification profile used to produce the executable. The compiler hash field 710 may be a hash, identifier, signature, certificate, build ID, or other toolchain-identifying value.

The ledger section 706 may include a static proof hash field 712. The static proof hash field 712 may store a proof hash, attestation hash, checksum, cryptographic digest, digital signature, Merkle root, certificate, or other integrity value associated with balance proof data, frame attestation data, contribution-map data, frame-boundary data, or other ledger-conformance data. SHA-256 is a preferred example of a hash mechanism, but the disclosed architecture is not limited to SHA-256.

The ledger section 706 may include a frame-count field 714. The frame-count field 714 may indicate the number of execution frames in the text section 702 or in a selected code region. The frame-count field 714 may be used by a loader, VM, hardware pre-verifier, audit tool, or runtime monitor to confirm that attestation data is complete and that executable instructions are properly partitioned into exactly eight-opcode frames.

The ledger section 706 may include a frame-attestation table 716. The frame-attestation table 716 may identify frame boundaries, frame starting addresses, frame ending addresses, EF flag locations, expected frame sums, contribution-map identifiers, static proof entries, branch-target constraints, exception-edge constraints, or other frame-level verification data. In some embodiments, the frame-attestation table 716 stores a compact record for each execution frame. In other embodiments, the frame-attestation table 716 stores a Merkle tree, compressed proof object, bitmap, checksum sequence, certificate chain, or other attestation structure.

A loader 718 reads the ledger-conformant executable 700. The loader 718 may be an operating-system loader, firmware loader, VM loader, secure-enclave loader, hypervisor, bootloader, smart-contract runtime, blockchain validator, embedded controller loader, FPGA configuration manager, or other component configured to prepare executable code for execution. The loader 718 may operate before runtime, during dynamic linking, during VM module loading, during secure enclave initialization, or during firmware boot.

The loader 718 may include a hash recomputation module 720. The hash recomputation module 720 recomputes, derives, or verifies an integrity value over the frame-attestation table 716, executable instructions, contribution map, frame-boundary metadata, compiler proof object, or another selected portion of the ledger-conformant executable 700. In signature-based embodiments, the hash recomputation module 720 may verify a digital signature, certificate, Merkle proof, or remote attestation response rather than merely recomputing a local hash.

The loader 718 may include a hash comparison module 722. The hash comparison module 722 compares the recomputed or verified integrity value with the static proof hash field 712 or another integrity value. If the values match or otherwise verify, the loader 718 may determine that the executable has not been altered in a way that invalidates the frame attestation data. If the values fail to match or fail to verify, the loader 718 may determine that the executable should not be executed by a compliant ledger-enforced engine.

When verification succeeds, the loader 718 follows an execution-accept path 724. Along the execution-accept path 724, the loader 718 may map the text section 702 into instruction memory, initialize VM state, configure the contribution map, configure frame-boundary metadata, initialize the balance accumulator, register the executable with an audit service, or otherwise prepare the executable for execution.

When verification fails, the loader 718 follows an execution-refusal path 726. Along the execution-refusal path 726, the loader 718 may refuse execution, raise an error, reject a module, quarantine a binary, terminate loading, alert a supervisor, request recompilation, log a diagnostic event, or place the system into a safe state. In one embodiment, the loader 718 produces an EBALANCE error output 728. The EBALANCE error output 728 may include a status code, exception record, audit event, security alert, VM error, operating-system error, or firmware error indicating ledger-conformance failure.

The binary format shown in FIG. 7 provides product and computer-readable-medium support for the disclosed invention. In some embodiments, the ledger-conformant executable itself is a protected product or stored article. The executable may include executable instructions, bytecode, firmware, microcode, or VM instructions arranged into exactly eight-opcode execution frames, together with ledger-conformance metadata that allows a loader, virtual machine, verifier, hardware engine, or runtime component to determine whether the executable satisfies the frame-balance rule. The ledger-conformance metadata may include a ledger section, executable manifest, frame-attestation table, contribution-map declaration, frame-boundary table, expected frame sums, proof hash, checksum, cryptographic digest, digital signature, Merkle root, certificate, compiler identifier, ISA version, or other integrity or conformance value. A non-transitory computer-readable medium may store the ledger-conformant executable, a compiler configured to generate the executable, a loader configured to verify the executable, a verifier configured to validate frame-balance metadata, or a virtual machine configured to enforce the zero-balance commit rule during execution. A ledger-conformant executable 700 may itself be an output product of the compiler workflow 600. The ledger section 706, static proof hash field 712, frame-attestation table 716, or loader verification protocol may provide additional protection against tampered opcodes, altered balance-class bits, removed compensating instructions, invalid EF flags, mismatched contribution maps, or other modifications that would undermine the frame-balance rule.

Although FIG. 7 depicts a ledger section 706 inside the ledger-conformant executable 700, other storage arrangements may be used. The ledger section 706 may be stored outside the executable, embedded in a signed manifest, placed in a package metadata file, stored in a secure database, retrieved from a remote attestation service, generated by a build system, supplied by a blockchain validator, or included in a VM module descriptor. The relevant feature is that ledger-conformance data is available to a loader, verifier, VM, hardware engine, or runtime component before or during execution.

The loader verification shown in FIG. 7 is a preferred security and product embodiment. Other embodiments may enforce the frame-balance rule at runtime without loader verification, or may emit frame-attested code for later verification.

FIG. 8 depicts a virtual machine 800 configured to execute ledger-conformant bytecode or opcode streams on non-native hardware. The virtual machine 800 may be implemented as a software interpreter, emulator, sandbox runtime, smart-contract VM, bytecode engine, secure enclave runtime, cloud execution runtime, JIT runtime, firmware simulator, or other software execution environment. The virtual machine 800 enforces the same eight-opcode zero-balance commit rule as a compatible hardware execution engine.

The virtual machine 800 receives a bytecode or opcode stream 802. The bytecode or opcode stream 802 may include opcodes having the same format as a hardware embodiment, a bytecode representation corresponding to the hardware format, a VM-specific instruction format carrying balance-class metadata, or another executable representation associated with balance classes and frame-boundary indications. The bytecode or opcode stream 802 is organized into execution frames of exactly eight opcodes.

A program counter 804 identifies the current instruction position in the bytecode or opcode stream 802. The program counter 804 may be a VM instruction pointer, bytecode offset, code address, frame-relative slot index, host pointer, interpreted index, or another execution-position value. The program counter 804 may be checkpointed so that VM state can be restored if a frame fails the zero-balance condition.

A fetch stage 806 retrieves an opcode from the bytecode or opcode stream 802. The fetch stage 806 may retrieve a fixed-length opcode, VM bytecode word, decoded instruction object, micro-op representation, or host-side instruction descriptor. In some embodiments, the fetch stage 806 also retrieves associated metadata, such as a balance-class tag, EF flag, frame-boundary table entry, or contribution-map identifier.

A decode stage 808 decodes the fetched opcode. The decode stage 808 may decode operation semantics, operand fields, register identifiers, immediates, branch offsets, memory addresses, balance-class metadata, and frame-boundary metadata. The decode stage 808 may be implemented by a table-driven interpreter, switch-based decoder, threaded interpreter, bytecode decoder, JIT front end, or other VM decoding mechanism.

A balance-class decoder 810 decodes the balance class associated with the opcode. The balance-class decoder 810 determines a signed contribution by applying a contribution map to the decoded balance class. The contribution map may be built into the VM, supplied by a bytecode profile, read from executable metadata, verified by a loader, or determined by a target ISA profile.

An EF flag decoder 812 detects whether the opcode marks a frame boundary. In a preferred embodiment, the EF flag decoder 812 detects a 1-bit EF flag in the eighth opcode of an execution frame. In alternative embodiments, the EF flag decoder 812 may be replaced by or cooperate with a frame-index counter, metadata lookup, bytecode boundary table, reserved boundary opcode detector, or other frame-boundary detection mechanism.

A host execution stage 814 executes the semantics of the decoded opcode on host hardware. The host execution stage 814 may update VM registers, VM stack state, VM memory, host memory, sandboxed memory, control-flow state, predicate state, or other VM-visible state. In some embodiments, the host execution stage 814 writes results to speculative VM state rather than immediately committing them. In other embodiments, host-side effects are reversible, checkpointed, buffered, or otherwise controlled until the frame boundary.

A software balance register 816 accumulates signed contributions associated with opcodes in the current execution frame. Although FIG. 8 refers to the software balance register 816, the virtual machine 800 may use any software balance accumulator, including a fixed-width integer, arbitrary-precision integer, host-native signed value, VM field, runtime object, interpreter variable, JIT-managed register, or memory-resident accumulator. The software balance register 816 is reset at the start of a frame or after commit or non-commit response.

VM checkpoint state 818 stores a recoverable state for the virtual machine 800. The VM checkpoint state 818 may include the program counter 804, VM registers, stack state, heap state, memory-write log, call frame, exception state, operand stack, gas or resource counter, security state, sandbox state, or other VM execution state. The VM checkpoint state 818 may be updated after a frame commits and restored when a frame fails the zero-balance condition.

An EF boundary check 820 determines whether the current opcode completes an eight-opcode execution frame. The EF boundary check 820 may be triggered by the EF flag decoder 812, by a frame index reaching the eighth slot, by metadata, or by another boundary indication. When the EF boundary check 820 indicates that the frame boundary has been reached, the virtual machine 800 performs a zero comparison 822.

The zero comparison 822 compares the software balance register 816 with zero. If the software balance register 816 equals zero, the virtual machine 800 follows a VM commit path 824. Along the VM commit path 824, VM state affected by the frame is committed, buffered host-side effects may be released, checkpoints may be advanced, and the software balance register 816 may be reset for the next frame.

If the software balance register 816 is nonzero, the virtual machine 800 follows a VM rollback path 826 or another non-commit path. Along the VM rollback path 826, the virtual machine 800 may restore the VM checkpoint state 818, discard speculative VM state, reset the program counter 804, invalidate buffered memory writes, restore a stack state, or otherwise reverse effects of the imbalanced frame.

The virtual machine 800 may also follow a VM exception path 828. Along the VM exception path 828, the virtual machine 800 may raise an imbalance exception, terminate execution, reject the bytecode module, report a security violation, notify a host runtime, return an EBALANCE-like error, log a diagnostic event, request recompilation, or enter a safe state. The VM exception path 828 may be selected instead of rollback or after rollback, depending on VM policy.

The virtual machine 800 may include an optional JIT compiler 830. The optional JIT compiler 830 may translate bytecode or opcode stream 802 into host-native instructions while preserving the same eight-opcode frame-balance rule. The JIT compiler 830 may emit host instruction groups corresponding to eight-opcode frames, insert host-side balance accumulation instructions, insert zero comparisons at frame boundaries, maintain host registers or memory fields corresponding to the software balance register 816, and route nonzero frame balances to rollback or exception handlers.

The virtual machine 800 provides a non-native execution embodiment of the disclosed architecture. A developer may test ledger-conformant code in the virtual machine 800 and later deploy the same or corresponding code to hardware. A hardware vendor may provide the virtual machine 800 for development, debugging, compatibility testing, formal verification, sandboxing, or fallback execution. A cloud or blockchain runtime may use the virtual machine 800 to enforce frame-balance rules without requiring custom processor hardware.

In some embodiments, the virtual machine 800 consumes the same frame-attestation data used by a hardware execution engine. For example, the virtual machine 800 may read a ledger section, verify a proof hash, validate frame boundaries, load a contribution map, and then execute bytecode frames while enforcing runtime zero-balance checks. This allows hardware and software execution paths to share a common frame-balance rule.

The virtual machine 800 enforces the ledger discipline by accumulating signed balance contributions and gating state commitment at each eight-opcode frame boundary, thereby preventing an imbalanced VM frame from being committed VM state.

FIG. 9 depicts a hardware execution engine 900. The hardware execution engine 900 is configured to execute ledger-conformant opcodes and to enforce the eight-opcode zero-balance commit rule at a hardware, firmware, microcode, or mixed hardware/software level. The hardware execution engine 900 may be implemented as an in-order processor, out-of-order processor, superscalar processor, microcoded processor, softcore FPGA processor, ASIC processor, coprocessor, secure enclave processor, embedded controller, accelerator, or other hardware execution device.

The hardware execution engine 900 includes an instruction fetch unit 902. The instruction fetch unit 902 retrieves opcodes from instruction memory, cache, firmware memory, bytecode memory, boot memory, secure memory, or another instruction source. The instruction fetch unit 902 may retrieve one opcode at a time, multiple opcodes at a time, an instruction bundle, a cache line, or a predecoded instruction group. In some embodiments, the instruction fetch unit 902 also retrieves frame-boundary metadata, frame-attestation metadata, or contribution-map metadata associated with the fetched opcodes.

The hardware execution engine 900 includes an instruction decoder 904. The instruction decoder 904 decodes each fetched opcode into operation-control signals, operand identifiers, register identifiers, immediate values, execution-unit controls, balance-class information, frame-boundary information, or other decoded fields. The instruction decoder 904 may be a fixed decoder, programmable decoder, microcode decoder, table-driven decoder, predecoder, or multi-stage decode pipeline.

A primary opcode decoder 906 decodes the primary opcode portion of an instruction. The primary opcode decoder 906 determines the functional operation to be performed, such as arithmetic, logic, memory access, branch, ledger operation, synchronization, system operation, vector operation, tensor operation, cryptographic operation, or vendor-defined operation. The primary opcode decoder 906 may route decoded instructions to one or more execution units.

A balance-class decoder 908 decodes the balance-class field or other balance metadata associated with the opcode. The balance-class decoder 908 may identify a positive class, negative class, neutral class, ledger-operation class, reserved class, vendor-defined class, or other balance class. The balance-class decoder 908 may operate in parallel with the primary opcode decoder 906 so that ordinary instruction semantics and ledger-enforcement semantics are decoded together.

A signed contribution lookup 910 maps the decoded balance class to a signed contribution value. In preferred embodiments, the signed contribution lookup 910 maps a positive arithmetic class to +1, a negative arithmetic class to −1, and one or more neutral classes to 0. In other embodiments, the signed contribution lookup 910 maps balance classes to bounded signed integers, signed fixed-point values, weighted values, profile-defined values, or other signed contribution values. The signed contribution lookup 910 may be hardwired, microcoded, programmable, profile-selected, loaded from executable metadata, or verified by a loader.

An EF detector 912 detects whether the current opcode is associated with a frame boundary. In a preferred embodiment, the EF detector 912 detects a 1-bit execution-frame flag in the eighth opcode of an execution frame. In other embodiments, the EF detector 912 may detect a reserved boundary opcode, read a frame-boundary table, respond to instruction-prefix metadata, cooperate with a frame counter, or receive microcode state identifying completion of an eight-opcode frame.

A frame counter 914 tracks the position of the current opcode within an execution frame. The frame counter 914 may count from zero to seven, from one to eight, or according to another eight-slot convention. The frame counter 914 may be reset at the beginning of each execution frame, after commit, after rollback, after trap handling, after context switching, or after loader initialization. In some embodiments, the frame counter 914 verifies that an EF flag appears at the expected final slot and may raise an exception if a boundary indication appears at an invalid slot.

A balance register 916 accumulates signed contributions associated with opcodes in the current execution frame. The balance register 916 is one hardware implementation of a balance accumulator. In preferred embodiments, the balance register 916 is a signed 128-bit two's-complement register. In other embodiments, the balance register 916 may have another width, may be implemented as multiple registers, may be implemented as a saturating or non-saturating accumulator, may be virtualized per thread or privilege domain, or may be implemented in microarchitectural state.

A zero comparator 918 compares the balance register 916 with zero at the frame boundary. The zero comparator 918 may be a combinational comparator, pipeline-stage comparator, microcode comparison, ALU comparison, or other hardware comparison circuit. The zero comparator 918 outputs a commit-allow signal when the balance register 916 equals zero and a non-commit or imbalance signal when the balance register 916 is nonzero.

The hardware execution engine 900 may maintain speculative architectural state 920. The speculative architectural state 920 may include register updates, memory writes, status flags, branch results, program counter updates, predicate updates, vector-register updates, special-purpose-register updates, or other state generated during execution of the current frame before the zero-balance condition is satisfied. The speculative architectural state 920 prevents effects of an imbalanced frame from becoming committed state.

Commit-control logic 922 controls whether state associated with an execution frame is committed. The commit-control logic 922 receives or otherwise uses the result of the zero comparator 918. When the balance register 916 equals zero at the frame boundary, the commit-control logic 922 permits frame state to commit. When the balance register 916 is nonzero, the commit-control logic 922 prevents commit and causes a non-commit response, such as rollback, trap, speculative-state discard, exception signaling, safe-state entry, or other recovery behavior.

A rollback checkpoint store 924 stores checkpoint information for restoring state when an execution frame is imbalanced. The rollback checkpoint store 924 may include a copy of architectural registers, program counter state, status flags, memory checkpoint pointers, store-buffer state, VM state, privilege state, security state, or other recovery information. In some embodiments, the rollback checkpoint store 924 is updated after each successful frame commit. In other embodiments, checkpointing may occur at selected intervals, privilege transitions, VM boundaries, or secure-execution boundaries.

A register file 926 stores architectural registers or other processor-visible registers. In a preferred embodiment, the register file 926 may include 64 general-purpose 32-bit registers addressable by a 6-bit destination-register field. In other embodiments, the register file 926 may include fewer or more registers, wider registers, vector registers, predicate registers, special-purpose registers, floating-point registers, capability registers, secure registers, VM registers, or other state-bearing elements.

A memory interface 928 allows the hardware execution engine 900 to read from and write to memory. The memory interface 928 may include load/store units, cache interfaces, bus interfaces, memory-management units, address-generation units, store buffers, write buffers, transaction buffers, memory-ordering logic, or secure-memory interfaces. In embodiments that buffer memory effects, store operations performed during a frame may be held until the zero-balance condition is satisfied.

An IMB flag register 930 stores an imbalance indication. The IMB flag register 930 may be set when an execution frame reaches a boundary with a nonzero accumulated balance. The IMB flag register 930 may be software-readable, privileged, debug-only, VM-visible, hypervisor-visible, or internal to the processor. In some embodiments, the IMB flag register 930 stores additional information, such as the frame identifier, frame balance value, program counter, failed contribution sum, or error class.

An exception handler interface 932 provides a path to software, firmware, microcode, a hypervisor, a secure monitor, a VM runtime, or another handler when an imbalance or invalid frame condition occurs. The exception handler interface 932 may deliver an exception vector, trap code, status word, diagnostic record, frame identifier, or other exception information. The exception handler interface 932 may also support recovery policies, including re-execution, process termination, safe-state entry, binary quarantine, or debugger intervention.

A debug or audit interface 934 may provide access to frame-balance events, commit events, imbalance events, proof-verification events, contribution-map data, frame counters, balance-register values, or other diagnostic information. The debug or audit interface 934 may be used for manufacturing test, certification support, runtime monitoring, security auditing, formal test harnesses, compiler validation, or development debugging. The debug or audit interface 934 is optional and is not required for the broad execution architecture.

During operation, the instruction fetch unit 902 retrieves an opcode, the instruction decoder 904 decodes the opcode, the primary opcode decoder 906 determines the operation semantics, and the balance-class decoder 908 determines the balance class. The signed contribution lookup 910 supplies a signed contribution value, and the balance register 916 accumulates that value. The frame counter 914 tracks the frame slot, and the EF detector 912 or another boundary mechanism determines whether the frame boundary has been reached. At the boundary, the zero comparator 918 determines whether the balance register 916 equals zero. The commit-control logic 922 either commits the speculative architectural state 920 or prevents commit and invokes the rollback checkpoint store 924, IMB flag register 930, exception handler interface 932, or another non-commit response path.

The hardware execution engine 900 may support out-of-order or superscalar execution. In such embodiments, individual opcodes may execute internally in an order different from program order, but the commit-control logic 922 preserves a defined eight-opcode frame membership. The processor may use a reorder buffer, commit queue, speculative state buffer, or transactional state to ensure that state associated with the frame is not committed until the zero comparator 918 confirms that the accumulated frame balance equals zero.

In a representative FPGA embodiment, the hardware execution engine may be implemented as a multi-core soft processor using per-core balance-accumulation and EF-boundary comparison logic. A representative implementation may target a Xilinx Ultrascale+ device, use approximately 2000 LUTs per core, approximately 20 k LUTs for a quad-core implementation, operate at about 250 MHz, and assert a frame-balance verdict on the EF-marked final opcode of each eight-opcode frame. These values are representative implementation details and do not limit the broader architecture.

The hardware execution engine 900 may be used alone or as part of a larger stack. In a hardware-only embodiment, the hardware execution engine 900 enforces the frame-balance rule without a virtual machine. In an ecosystem embodiment, the hardware execution engine 900 executes code generated by a compiler balance pass and verified by a loader using a frame-attestation table. In a co-verification embodiment, the hardware execution engine 900 and a virtual-machine execution engine enforce the same frame-balance rule, allowing development, simulation, and deployment to share the same invariant.

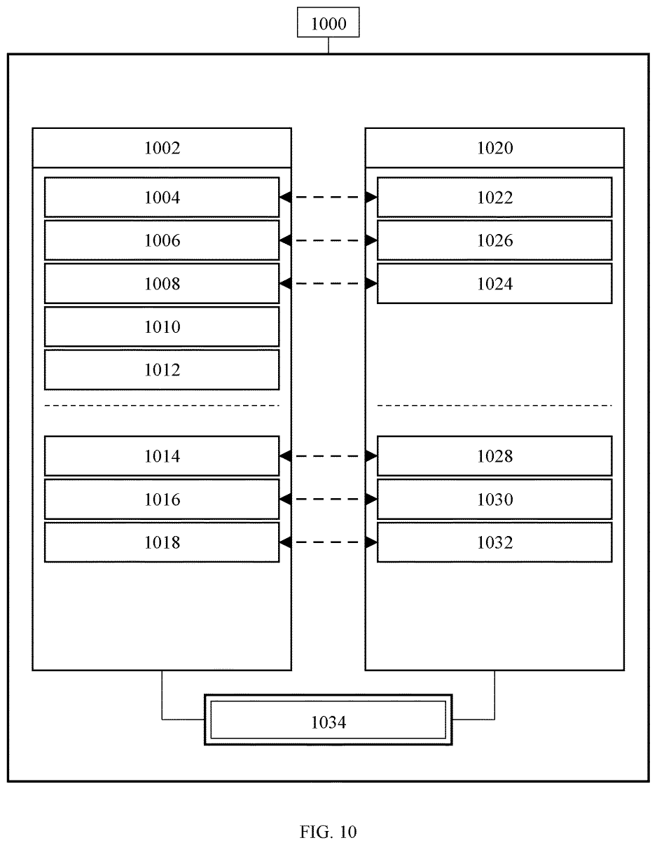

FIG. 10 depicts a formal correspondence map 1000. The formal correspondence map 1000 illustrates relationships between a patent-specific ledger-enforced ISA formalization and an antecedent LNAL formalization. FIG. 10 is intended to identify formal support and semantic correspondence without limiting the disclosed instruction-set architecture to a byte-for-byte representation of any antecedent instruction language.

The formal correspondence map 1000 includes a patent-specific ISA module 1002. The patent-specific ISA module 1002 formalizes the concrete structures used by the disclosed ledger-enforced architecture. In some embodiments, the patent-specific ISA module 1002 is implemented in a formal proof system and includes definitions, structures, functions, and theorems describing opcode balance classes, execution frames, balance accumulators, compiler balance passes, VM state, executable headers, and commit conditions.

An OpcodeFormat structure 1004 represents the opcode format of the disclosed architecture. The OpcodeFormat structure 1004 may include fields corresponding to a primary opcode, balance class, execution-frame flag, destination-register field, immediate field, source-register field, or other operand field. The OpcodeFormat structure 1004 provides formal support for embodiments in which balance metadata is embedded in or associated with executable opcode representations.

An ExecutionFrame structure 1006 represents an execution frame of exactly eight opcodes. In the formalized core, the ExecutionFrame structure 1006 may include a function, vector, array, tuple, or indexed structure representing eight opcode slots. The ExecutionFrame structure 1006 supports the frame-level invariant that a signed balance contribution is obtained from each opcode and that the sum across exactly eight opcode slots must equal zero before commit.

A BalanceRegister structure 1008 represents a balance register or balance accumulator. The BalanceRegister structure 1008 may model a signed register, integer accumulator, bounded accumulator, software value, or other storage for frame-balance accumulation. The BalanceRegister structure 1008 supports formal statements about zero comparison, commit permission, reset behavior, and frame-balance accumulation.

A CompilerBalancePass structure 1010 represents compiler-side generation or verification of balanced frames. The CompilerBalancePass structure 1010 may model a compiler pass that partitions operations into frames, assigns balance classes, computes frame sums, inserts or selects balancing operations, and emits balanced frames. The formalization may include a theorem establishing that frames emitted by the compiler balance pass are balanced under the applicable contribution map.

A VMState structure 1012 represents virtual-machine execution state. The VMState structure 1012 may include a software balance accumulator, frame index, program counter, committed state, speculative state, rollback checkpoint, or other VM execution fields. The VMState structure 1012 provides formal support for a virtual-machine embodiment enforcing the same frame-balance rule as a hardware embodiment.

A zero_allows_commit theorem 1014 represents a formalized statement that a zero balance value permits commit under the modeled commit condition. In one implementation, the theorem states that when the balance register or accumulator equals zero, the commitAllowed condition is satisfied. This theorem supports the central machine rule that zero accumulated frame balance is the condition under which architectural or VM state may commit.

A balanced_compiler_correct theorem 1016 represents a formalized compiler-correctness statement. In one implementation, the theorem states that frames emitted by the compiler balance pass satisfy the balanced-frame predicate. The balanced_compiler_correct theorem 1016 supports compiler embodiments in which ledger-conformant code is generated statically before execution and then enforced dynamically by hardware or a VM.

A ledger_enforced_isa_viable theorem 1018 represents a master or summary certificate for the patent-specific ISA formalization. The theorem 1018 may combine the eight-slot structure, contribution-map logic, zero-balance commit rule, compiler-balance correctness, VM correspondence, and related formal support. The theorem 1018 is a credibility and verification anchor. It is not required that every implementation use a formal proof system unless a claim expressly recites such verification.

The formal correspondence map 1000 also includes an LNAL antecedent layer 1020. The LNAL antecedent layer 1020 provides semantic and formal antecedents for an eight-step boundary-neutrality discipline. The LNAL antecedent layer 1020 is useful for understanding and verifying the disclosed architecture, but the disclosed architecture is not limited to the antecedent surface syntax or byte-level representation of LNAL.

An LNAL opcode family 1022 may include opcodes such as LOCK, BALANCE, FOLD, SEED, BRAID, MERGE, LISTEN, and FLIP. These opcodes may be mapped into balance classes in the disclosed architecture. For example, FOLD and SEED may map to positive contribution classes, BRAID and MERGE may map to negative contribution classes, and LOCK, BALANCE, LISTEN, and FLIP may map to neutral classes. This mapping provides an example of how an antecedent eight-operation semantic family can be represented in the disclosed balance-class taxonomy.

A winSum8 state variable 1024 represents a windowed sum in the antecedent LNAL VM. The winSum8 state variable 1024 is semantically analogous to a balance accumulator or balance register in the disclosed patent-specific architecture. Both structures represent accumulated balance over an eight-step or eight-opcode window.

A winIdx8 state variable 1026 represents an eight-position frame or window index in the antecedent LNAL VM. The winIdx8 state variable 1026 is semantically analogous to a frame counter or frame index in the disclosed architecture. Both structures identify progress through an eight-position window or frame.

A neutral_at_any_boundary theorem 1028 represents an antecedent boundary-neutrality invariant. In one formalization, the theorem states that under specified scheduler and running-state conditions, a boundary operation resets the windowed sum and frame index at an eight-step boundary. This theorem provides antecedent support for the concept of eight-step boundary neutrality.

A neutral_every_8th_from0 theorem 1030 represents a theorem that neutrality occurs at every eighth boundary from a starting condition. This theorem supports the use of an eight-step periodicity as a formal boundary discipline.

A schedule_neutrality_rotation theorem 1032 represents a theorem that the neutrality condition is compatible with rotations or different starting points in the eight-step schedule. This theorem supports robustness of the eight-step boundary-neutrality concept.

A non-identity boundary note 1034 identifies the important boundary between the patent-specific architecture and the LNAL antecedent layer 1020. The disclosed ISA is a concrete ledger-enforced derivative inspired by or corresponding to antecedent LNAL structures. It need not be a byte-for-byte restatement of an existing LNAL instruction representation. For example, an antecedent LNAL instruction may be an abstract opcode-and-argument pair, whereas the disclosed preferred ISA may use a concrete fixed-length opcode word having primary opcode, balance-class, EF flag, destination, and operand fields.

The formal correspondence map 1000 supports several parts of the disclosed patent architecture. It supports the eight-opcode frame requirement by showing correspondence to an eight-step boundary-neutrality discipline. It supports the balance accumulator by showing correspondence to winSum8. It supports the frame index by showing correspondence to winIdx8. It supports compiler and VM embodiments by showing that both static and runtime structures can be formalized. It also supports claim discipline by distinguishing formal antecedent correspondence from concrete opcode identity.

Formal verification is a strategic credibility anchor and may support verification-oriented embodiments, but the broad execution architecture may be practiced without requiring a particular proof system.

The formal correspondence map 1000 also clarifies the distinction between demonstrated or formally supported material and design targets. Formal theorems relating to zero-balance commit, compiler-balanced frames, and eight-step boundary neutrality may be identified as verification anchors. Performance targets, imbalance-rate targets, compilation-overhead targets, ASIC projections, and downstream certification outcomes should be treated as design targets or prophetic embodiments unless separately demonstrated.

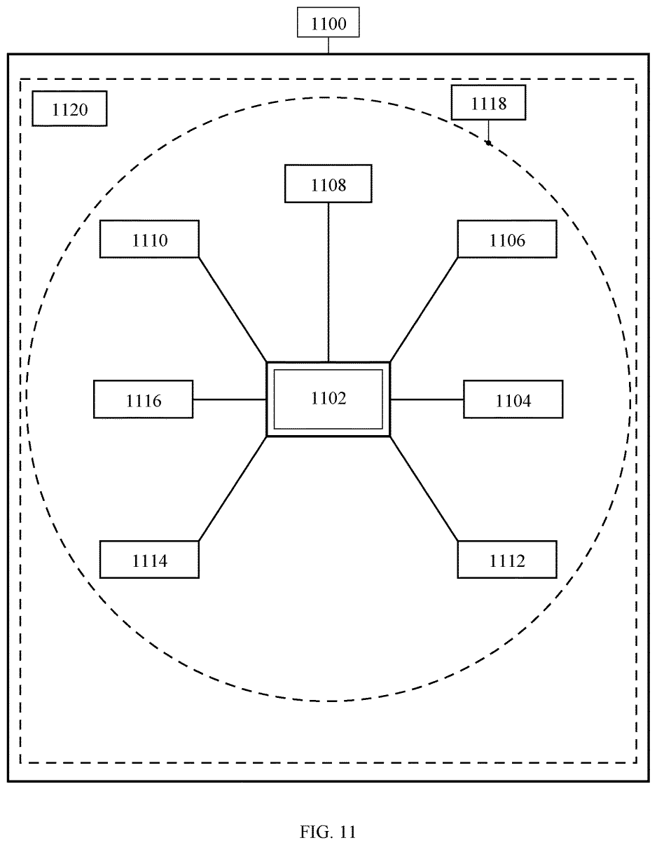

FIG. 11 depicts a downstream embodiment map 1100. The downstream embodiment map 1100 illustrates non-limiting application environments in which the disclosed ledger-enforced execution architecture may be used. The downstream embodiments shown in FIG. 11 do not redefine the core invention. The core invention remains the eight-opcode zero-balance commit discipline implemented by executable balance metadata, signed contribution accumulation, frame-boundary zero comparison, and non-commit response.

The downstream embodiment map 1100 includes a core ledger-enforced ISA 1102. The core ledger-enforced ISA 1102 represents the instruction-set architecture, opcode format, balance-class taxonomy, execution-frame rule, balance accumulator, frame-boundary logic, and commit-control discipline described above. Each downstream embodiment is connected to the core ledger-enforced ISA 1102 through the same basic enforcement mechanism.

A safety-critical processor 1104 may implement the core ledger-enforced ISA 1102. The safety-critical processor 1104 may be used in automotive systems, avionics systems, medical-device controllers, robotics, industrial automation, power systems, rail systems, or other environments in which fault detection, deterministic rollback, or safe-state entry is important. In such embodiments, a nonzero frame balance may cause rollback, trap, safe-state entry, diagnostic logging, or handoff to a safety monitor. The disclosed architecture may support safety assurance activities, but the disclosure does not assert regulatory certification unless such certification is separately obtained.

A blockchain execution engine 1106 may implement the core ledger-enforced ISA 1102 or a VM embodiment thereof. The blockchain execution engine 1106 may execute smart contracts, validator code, transaction logic, consensus code, cryptographic routines, or deterministic VM bytecode. The ledger-enforced execution mechanism may provide frame-level execution integrity, tamper resistance, or deterministic rollback behavior. The architecture does not by itself prove correctness of arbitrary smart-contract logic unless separate program-level correctness proofs are provided.

An AI inference accelerator 1108 may implement the core ledger-enforced ISA 1102. The AI inference accelerator 1108 may execute matrix operations, tensor operations, multiply-accumulate operations, activation functions, normalization operations, attention operations, embedding operations, or model-control logic using ledger-conformant frames. The frame-balance rule may help detect or prevent commitment of imbalanced execution frames. The disclosed architecture does not by itself guarantee AI model accuracy, fairness, robustness, or application-level correctness.

A quantum error-correction controller 1110 may implement the core ledger-enforced ISA 1102. The quantum error-correction controller 1110 may execute classical control instructions, syndrome decoding routines, feedback-control logic, timing logic, calibration routines, or hardware-interface code associated with a quantum computing system. In such embodiments, frame-level balance enforcement may protect classical control execution from certain imbalance or tampering events. Cryogenic operation, specific surface-code performance, and quantum-correction success rates are downstream or prophetic implementation matters unless separately supported.

A secure enclave processor 1112 may implement the core ledger-enforced ISA 1102. The secure enclave processor 1112 may be used in cryptographic key management, secure boot, hardware security modules, trusted execution environments, authentication systems, anti-tamper systems, or fault-injection-resistant controllers. In such embodiments, an altered opcode, modified balance-class bit, removed compensating instruction, invalid frame boundary, or tampered binary metadata may lead to imbalance detection, loader refusal, rollback, trap, or safe-state entry. The secure enclave processor 1112 is a downstream security embodiment and is not required for practicing the core execution rule.

A high-performance computing node 1114 may implement the core ledger-enforced ISA 1102. The high-performance computing node 1114 may execute scientific computing workloads, simulations, numerical kernels, cryptographic workloads, data analytics, or distributed computing tasks. Frame-level ledger enforcement may provide bounded instruction-frame integrity checks, rollback points, or audit records. The degree of performance overhead or error-detection coverage may depend on implementation details and should not be treated as a universal guarantee absent specific benchmark data.

An edge or IoT FPGA device 1116 may implement the core ledger-enforced ISA 1102. The edge or IoT FPGA device 1116 may be used in sensors, controllers, embedded systems, field devices, drones, wearables, industrial equipment, robotics, or low-power inference devices. An FPGA softcore, microcontroller, or embedded processor may implement balance-class decoding, frame-boundary detection, balance accumulation, and zero-balance commit control. FPGA area, clock speed, throughput, and power targets are implementation-specific and should be treated as preferred or projected embodiments unless measured for a particular implementation.

Each downstream embodiment shown in the downstream embodiment map 1100 is connected by a common frame-balance enforcement link 1118. The common frame-balance enforcement link 1118 represents the shared enforcement mechanism: opcodes carry balance-class metadata, exactly eight opcodes form an execution frame, signed contributions are accumulated over the frame, and state commits only when the accumulated frame balance equals zero. This link is what makes the downstream embodiments part of the same inventive architecture rather than separate unrelated applications.

Each downstream embodiment may also include application-specific logic 1120. The application-specific logic 1120 may include safety monitors, blockchain consensus rules, tensor accelerators, quantum-control interfaces, cryptographic engines, secure memory, scientific-computing libraries, embedded I/O, or other domain-specific logic. The application-specific logic 1120 may use or benefit from the ledger-enforced execution rule, but the application-specific logic 1120 should not be understood as replacing or redefining the core invention.

The downstream embodiment map 1100 is intentionally subordinate to the core architecture. The disclosed invention is not an AI model, not a blockchain protocol, not a quantum error-correction algorithm, not a safety certification, and not a secure enclave by itself. Instead, the invention is an instruction-execution architecture that can be used within those environments. This separation preserves the identity of the invention while supporting broad downstream written description.

Downstream embodiments may provide continuation claim targets, including secure enclave, AI accelerator, blockchain VM, and quantum-controller implementations, while the core execution architecture remains the central invention.

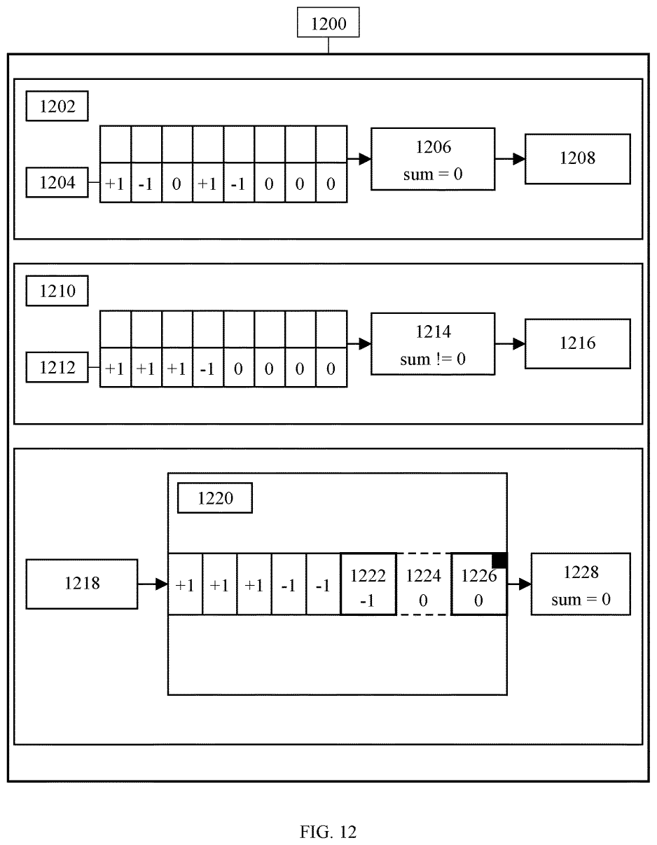

FIG. 12 depicts worked frame examples 1200. The worked frame examples 1200 illustrate how the disclosed frame-balance rule operates for a balanced execution frame, an imbalanced execution frame, and a compiler-corrected execution frame. The examples are simplified for clarity. Actual opcodes may include primary opcode fields, balance-class fields, frame-boundary indications, destination fields, immediate fields, source-register fields, memory operands, branch operands, or other instruction fields as described above.

A balanced frame example 1202 includes eight opcodes whose associated signed contributions produce a zero frame balance. In one example, the balanced frame example 1202 includes a contribution pattern of:

+1, −1, +1, −1, 0, 0, 0, 0

This contribution pattern is illustrative. Other balanced contribution patterns may be used, including patterns with different positive and negative values, different neutral slots, or contribution values determined by a different contribution map, provided that the accumulated frame balance equals zero at the frame boundary.

The balanced frame example 1202 includes balanced frame contributions 1204. The balanced frame contributions 1204 may correspond to an addition instruction, subtraction instruction, another addition instruction, another subtraction instruction, and four neutral instructions. For example, a first addition-like opcode may contribute +1, a first subtraction-like opcode may contribute −1, a second addition-like opcode may contribute +1, a second subtraction-like opcode may contribute −1, and logic, branch, memory, ledger-operation, or no-op-like opcodes may contribute 0.

The balanced frame contributions 1204 yield a balanced frame zero sum 1206. The balanced frame zero sum 1206 may be expressed as:

+1+−1++1+−1+0+0+0+0=0

At the frame boundary, the balance accumulator equals zero. Accordingly, the execution engine follows a commit result 1208. The commit result 1208 may include promotion of speculative state to committed architectural state, update of a rollback checkpoint, advancement of a frame counter, reset of the balance accumulator, release of buffered memory writes, or another commit action appropriate to the implementation.

An imbalanced frame example 1210 includes eight opcodes whose associated signed contributions produce a nonzero frame balance. In one example, the imbalanced frame example 1210 includes a contribution pattern of:

+1, +1, +1, −1, 0, 0, 0, 0

The imbalanced frame example 1210 includes imbalanced frame contributions 1212. The imbalanced frame contributions 1212 may arise from an instruction sequence that contains three positive-contribution operations and only one negative-contribution operation, with the remaining operations being neutral. The imbalance may be caused by an unbalanced compiler output, binary tampering, instruction corruption, invalid contribution-map interpretation, fault injection, transient hardware error, VM corruption, or another cause.

The imbalanced frame contributions 1212 yield a nonzero sum 1214. The nonzero sum 1214 may be expressed as:

+1++1++1+−1+0+0+0+0=+2

At the frame boundary, the balance accumulator is nonzero. Accordingly, the execution engine does not permit the frame to commit. The execution engine follows a rollback result 1216 or another non-commit response. The rollback result 1216 may include restoring a prior checkpoint, discarding speculative state, raising an IMB flag, trapping to software, terminating execution, refusing execution, re-executing the frame, logging a diagnostic event, or entering a safe state.

A naive IR example 1218 illustrates a source-level or intermediate-representation sequence that is not yet frame-balanced. In one example, a source expression such as:

a=b+c+d

may produce a naive intermediate representation having two addition-like operations. If each addition-like operation is assigned a positive contribution of +1, the naive IR example 1218 may have a partial frame balance of +2 before correction. Standing alone, such a sequence would not satisfy the zero-balance commit condition unless paired with negative or otherwise compensating contributions within the same eight-opcode execution frame.

A compiler-corrected frame 1220 illustrates how a compiler balance pass can transform the naive IR example 1218 into a ledger-conformant execution frame. The compiler-corrected frame 1220 may include the original operations, one or more compensating operations, and one or more neutral padding operations. The compiler may perform the correction while preserving program semantics.

The compiler-corrected frame 1220 may include a compensating opcode 1222. The compensating opcode 1222 may be an architecturally neutral opcode that carries a negative signed contribution. For example, if the naive IR example 1218 has a partial contribution of +2, the compiler may insert two negative compensating opcodes, each having a contribution of −1. The compensating opcode 1222 may have no program-visible effect other than its balance contribution, or may implement a paired, reversible, neutral, ledger, or target-specific operation selected by the compiler.

The compiler-corrected frame 1220 may also include a neutral padding opcode 1224. The neutral padding opcode 1224 may occupy an unused frame slot while contributing 0 to the frame balance. The neutral padding opcode 1224 may be a NOP, logic no-op, move-to-self operation, predicate-safe operation, VM no-op, microcode no-op, or another instruction defined as neutral by the applicable ISA profile.

The compiler-corrected frame 1220 includes an EF-marked final opcode 1226 in a preferred embodiment. The EF-marked final opcode 1226 identifies the final slot of the eight-opcode execution frame. In other embodiments, the final slot may be identified by a frame-boundary table, implicit frame counter, reserved boundary opcode, bytecode marker, microcode state, or other frame-boundary indication.

The compiler-corrected frame 1220 yields a corrected zero-sum result 1228. In one example, the corrected frame may include a contribution sequence of:

+1, +1, −1, −1, 0, 0, 0, 0

The corrected zero-sum result 1228 may be expressed as:

+1++1+−1+−1+0+0+0+0=0

At the frame boundary, the balance accumulator equals zero. Accordingly, the compiler-corrected frame 1220 is eligible to commit when executed by a compliant hardware execution engine or virtual-machine execution engine.

The worked frame examples 1200 illustrate that ordinary operations may be assigned signed contributions independently from their full program semantics, that a compiler may construct balanced frames before runtime, and that runtime enforcement remains useful because tampering, transient faults, invalid metadata, or other failures may still produce an imbalanced frame.

The examples in FIG. 12 are not intended to limit the contribution map to +1, −1, and 0 values. In other embodiments, a contribution map may use multiple positive levels, multiple negative levels, weighted signed values, signed fixed-point values, or profile-defined values. In each case, the frame-level commit condition remains that the accumulated signed frame balance satisfies the zero-balance condition at the boundary of the exactly eight-opcode execution frame.

The examples in FIG. 12 also are not intended to require the use of compensating opcodes in all compiler-generated frames. A compiler may produce balanced frames by reordering operations, selecting alternative instruction encodings, distributing operations across adjacent frames, substituting equivalent instruction sequences, using paired operations, inserting neutral padding, or applying other semantic-preserving transformations. Compensating opcodes are a preferred and useful balancing mechanism, but they are not the only disclosed mechanism.

In some embodiments, the disclosed architecture is implemented using a processor pipeline. The pipeline may include fetch, decode, execute, writeback, and commit stages. The balance-class field may be decoded during the decode stage, and the signed contribution may be added to the balance accumulator during or after execution of the corresponding opcode. The frame-boundary indication may be detected during decode, execute, or commit, and the zero comparison may be performed before retirement of the final opcode of the frame.

In other embodiments, the disclosed architecture is implemented in a microcoded engine. A microcode controller may decode each opcode, determine the signed contribution associated with the opcode, update a microarchitectural balance accumulator, and branch to commit or non-commit microcode at the frame boundary. The microcoded engine may use the same frame-balance rule even if the underlying micro-operations differ from the externally visible opcodes.

In still other embodiments, the disclosed architecture is implemented as a software runtime, emulator, or virtual machine. A software interpreter may maintain a frame index, software balance accumulator, committed state, and checkpoint state. At each opcode, the interpreter may update the software balance accumulator according to the decoded balance class. At the eighth opcode or other frame-boundary indication, the interpreter may compare the software balance accumulator with zero and commit or restore VM state accordingly.

In some embodiments, the balance accumulator is reset at the start of each execution frame. In other embodiments, the balance accumulator is reset after a successful commit, after a rollback, after a trap, or after a loader-defined initialization step. In diagnostic embodiments, the balance accumulator value that caused failure may be preserved in an audit register, exception record, trace buffer, VM error object, or external log before reset.

In some embodiments, the execution engine validates frame structure before or during execution. Validation may include confirming that each frame includes exactly eight opcodes, that a frame-boundary indication appears in the expected final slot, that a contribution map is available, that branch targets land on permitted boundaries, that exception edges preserve frame discipline, or that executable metadata matches the loaded code. Such validation may be performed by a loader, compiler, verifier, VM, hardware decoder, microcode layer, or runtime monitor.

In some embodiments, branch and control-flow instructions are constrained so that execution remains frame-disciplined. A branch may target the first opcode of an execution frame, a permitted frame entry point, or a location identified by frame metadata. In other embodiments, branch operations may occur within a frame if the execution engine maintains correct frame membership and commit discipline. For branch, call, return, exception, or indirect-control-transfer operations, frame membership may be preserved by compiler restrictions, loader verification, frame-boundary metadata, branch-target tables, runtime checks, or hardware frame-index logic. A compliant implementation may require a control-transfer target to correspond to a permitted frame entry point, may require that an in-frame control transfer preserve a determinable eight-opcode frame membership, or may route an invalid frame transition to a non-commit response. These mechanisms ensure that control-flow changes do not bypass the zero-balance commit condition. A branch that would violate frame membership may cause a trap, loader refusal, static compiler diagnostic, or non-commit response.

In some embodiments, memory effects are buffered until the frame commits. For example, store operations may write to a store buffer, speculative memory buffer, transactional memory region, or shadow memory until the zero-balance condition is satisfied. If the frame commits, the buffered memory effects may be made visible. If the frame fails, the buffered memory effects may be discarded. In other embodiments, memory effects may be reversible or checkpointed.

In some embodiments, the disclosed architecture supports context switching. A context-switch event may save the balance accumulator, frame index, speculative state, contribution-map identifier, frame metadata pointer, and other ledger-enforcement state. When the context is restored, execution may resume with the same frame membership and accumulated balance. Alternatively, a context switch may be permitted only at frame boundaries after a successful commit.

In some embodiments, the disclosed architecture supports privilege levels. A privileged mode may configure contribution maps, enable or disable vendor-defined classes, read diagnostic state, handle imbalance exceptions, validate executable metadata, or control non-commit response policy. A user mode may execute ledger-conformant code without direct access to the balance accumulator except through defined status, exception, or audit interfaces.

In some embodiments, multiple hardware threads, cores, or VM instances each maintain a separate balance accumulator and frame index. In other embodiments, a shared execution engine may virtualize balance accumulators per thread, process, VM, enclave, or security domain. A multicore embodiment may include multiple ledger-enforced cores, each enforcing the eight-opcode frame-balance rule independently.

In some embodiments, the disclosed architecture supports interrupts and exceptions. An interrupt may be delayed until a frame boundary, serviced using a checkpointed state, or treated as a special frame-transition event. An exception occurring within a frame may cause rollback, trap, frame abort, or exception-frame construction. The precise interrupt and exception policy may be selected according to implementation requirements, but the frame-balance rule remains the commit criterion for ordinary frame completion.

In some embodiments, the disclosed architecture supports debugging. A debugger may inspect frame boundaries, balance-class fields, contribution values, balance accumulator values, commit decisions, rollback events, and proof or attestation data. A debug mode may allow single-frame stepping, frame replay, frame-balance visualization, breakpoints on imbalance, or inspection of speculative state. Debug access may be privileged or restricted to avoid bypassing the commit discipline.

In some embodiments, the disclosed architecture supports auditing. An audit log may record committed frames, failed frames, nonzero balance values, frame identifiers, program counters, contribution sequences, proof hashes, loader verification results, imbalance exceptions, rollback events, or safe-state events. Such audit logs may be useful in safety-critical systems, secure systems, blockchain runtimes, development environments, or certification-support workflows.

The disclosed architecture may be supported by formal verification. In one formalized embodiment, a patent-specific module, Applied.LedgerEnforcedISA, defines BalanceClass, OpcodeFormat, ExecutionFrame, BalanceRegister, ArchState, CompilerBalancePass, VMState, LedgerBinaryHeader, and lnalToBalanceClass. Formal verification anchors may include zero_allows_commit, establishing that zero accumulated balance permits commit; balanced_compiler_correct, establishing that compiler-emitted frames are balanced; lnal_vm_correspondence, relating the patent-specific architecture to an LNAL antecedent; and ledger_enforced_isa_viable, providing a summary certificate for the eight-opcode zero-balance commit architecture. In one embodiment, a formal module defines balance classes, opcode formats, execution frames, balance accumulators, compiler balance passes, VM state, binary headers, and commit conditions. Formal theorems may establish that a zero balance accumulator value permits commit, that compiler-emitted frames are balanced, that a VM state applies the frame-balance rule, and that an eight-step boundary-neutrality antecedent corresponds to the disclosed frame discipline. Antecedent LNAL invariants may include neutral_at_any_boundary, neutral_every_8th_from0, schedule_neutrality_rotation, lStep_preserves_VMInvariant, and lCycle_preserves_VMInvariant. In such embodiments, winSum8 provides a semantic antecedent for a balance accumulator and winIdx8 provides a semantic antecedent for an eight-position frame index.

Formal verification is not required to practice the broad execution architecture unless expressly recited in a claim. An implementation may practice the invention by implementing opcode balance metadata, exactly eight-opcode frames, signed contribution accumulation, frame-boundary zero comparison, and non-commit response. Formal proof artifacts, proof hashes, theorem-backed compilers, or machine-checked certificates may be used as preferred verification embodiments.

In some embodiments, verification of the ledger-enforced architecture may include proving, checking, or validating one or more of: an eight-slot boundary-neutrality property; a zero-balance commit admissibility property; a compiler-correctness property establishing that emitted frames are balanced; a virtual-machine correspondence property establishing that a software balance accumulator applies the same rule as a hardware balance accumulator; a loader-verification property establishing that executable metadata matches the executable frame structure; or an antecedent-correspondence property relating an eight-step formal model to the eight-opcode execution-frame discipline. The verification may be performed using a theorem prover, model checker, static analyzer, symbolic execution engine, proof-carrying-code system, compiler audit tool, runtime verifier, or other formal or semi-formal verification tool. These verification embodiments support auditability and implementation assurance, but the broad execution architecture remains operable without requiring any particular proof system.

Where formal verification is described, the scope of the verification should be understood according to what is actually verified. For example, a theorem that a zero accumulated balance permits commit supports the commit rule; a theorem that compiler-emitted frames are balanced supports the compiler balance pass; and a theorem about eight-step boundary neutrality supports the eight-frame antecedent. Design targets, such as overhead targets, imbalance-rate targets, ASIC performance targets, or certification outcomes, should not be treated as formal benchmark certificates unless separately verified or demonstrated.

The disclosed architecture may be implemented in a variety of downstream systems. Non-limiting examples include safety-critical processors, automotive controllers, avionics controllers, medical-device controllers, industrial controllers, blockchain execution engines, smart-contract virtual machines, artificial-intelligence inference accelerators, quantum error-correction controllers, secure enclave processors, hardware security modules, high-performance computing systems, edge devices, and Internet-of-things devices.

These downstream embodiments use the ledger-enforced execution mechanism to improve execution integrity, frame-balance enforcement, tamper resistance, rollback behavior, diagnostic visibility, or fault-detection granularity. The improvement provided by the disclosed architecture is a computer-architecture improvement in how executable operations are encoded, accumulated, checked, and committed. The frame-balance rule operates before or at state commitment and therefore provides a structural commit gate rather than merely an after-the-fact software assertion. The disclosed architecture does not require any particular application algorithm to be correct, does not require any particular certification outcome, and does not guarantee that all possible faults are detected. Rather, the architecture provides a concrete opcode-level and frame-level enforcement mechanism that may be used by downstream systems as one component of a broader safety, security, reliability, or verification strategy. Unless separately supported and expressly claimed, the disclosed architecture does not by itself prove correctness of arbitrary application logic, guarantee correctness of arbitrary smart contracts, guarantee artificial-intelligence model accuracy, guarantee quantum error-correction success, guarantee elimination of all silent data corruption, or supply regulatory certification.

Projected embodiments may include ASIC implementations, large multicore implementations, cryogenic implementations, accelerator implementations, security-certified implementations, or performance-optimized implementations. Such projected embodiments show implementation flexibility and downstream utility. Performance, area, power, certification, and imbalance-escape targets should be treated as design targets unless separately demonstrated.

The disclosed architecture supports method, system, apparatus, compiler, virtual-machine, binary-format, loader, and computer-readable-medium implementations. A method implementation may include fetching or receiving opcodes, decoding balance classes, accumulating signed contributions, detecting an eight-opcode frame boundary, comparing the accumulated balance with zero, committing state only if the accumulated balance equals zero, and performing a non-commit response when the accumulated balance is nonzero.

A system implementation may include an execution engine, balance-class decoder, contribution-map logic, balance accumulator, frame-boundary detector, zero comparator, commit-control logic, speculative-state storage, checkpoint storage, and exception or audit interface. A compiler implementation may include a balance-class assignment module, frame partitioner, frame-sum calculator, dependency checker, reordering module, compensation module, padding module, static balance solver, proof or attestation generator, and binary emitter. A virtual-machine implementation may include a fetch/decode loop, software balance accumulator, VM checkpoint state, frame-boundary check, zero comparison, commit path, rollback path, and optional JIT compiler.

A product implementation may include a ledger-conformant executable, bytecode module, firmware image, FPGA configuration package, executable manifest, ledger section, frame-attestation table, contribution-map declaration, proof hash, integrity value, or loader-verifiable metadata. A non-transitory computer-readable medium may store instructions that cause a processor, compiler, VM, loader, or verifier to perform any of the disclosed methods.

The disclosed ledger-enforced architecture provides a concrete computer-architecture mechanism for enforcing algebraic frame neutrality at the instruction-execution level. By embedding balance-class metadata into or associating it with executable opcodes, organizing execution into exactly eight-opcode frames, accumulating signed contributions over each frame, and allowing commit only when the accumulated frame balance equals zero, the architecture provides an enforcement boundary that is earlier and more structural than many after-the-fact software or redundancy-based checks.

The disclosed architecture also preserves implementation flexibility. The balance accumulator may be hardware or software. The frame-boundary indication may be an EF flag or another boundary marker. The contribution map may use +1, −1, and 0 values or other signed values. The compiler may balance frames using multiple semantic-preserving techniques. The executable may store ledger metadata internally or externally. The execution engine may be a hardware processor, microcoded engine, VM, emulator, secure enclave, coprocessor, FPGA softcore, or ASIC. These variations do not alter the core rule that an exactly eight-opcode frame must satisfy a zero-balance condition before state associated with the frame is committed.

The embodiments described herein are illustrative and not limiting. Features described in connection with one embodiment may be combined with features described in connection with another embodiment unless the combination is technically inconsistent.

What is claimed is:

1. A method of executing ledger-enforced instructions, comprising:
resetting, by an execution engine, a balance accumulator to zero at a start of a current execution frame;
receiving, by the execution engine, an opcode stream comprising fixed-length opcodes, each opcode including balance-class metadata designating a signed algebraic contribution under a contribution map;
organizing the opcode stream into execution frames, each execution frame consisting of exactly eight opcodes;
accumulating, in the balance accumulator, the signed algebraic contributions of the exactly eight opcodes of the current execution frame;
determining that a frame boundary of the current execution frame has been reached;
comparing the balance accumulator with zero at the frame boundary;
permitting architectural state or virtual-machine state associated with the current execution frame to commit only when the balance accumulator equals zero at the frame boundary; and
performing a non-commit response when the balance accumulator is nonzero at the frame boundary.

2. The method according to claim 1, wherein the frame boundary is identified by an execution-frame flag associated with a final opcode of the current execution frame.

3. The method according to claim 1, wherein the contribution map assigns a positive signed contribution to an arithmetic-add class, a negative signed contribution to an arithmetic-subtract class, and a neutral contribution to at least one logic, memory, branch, ledger-operation, reserved, or vendor-defined class.

4. The method according to claim 1, wherein each fixed-length opcode is a 32-bit instruction word including a primary opcode field, a balance-class field, an execution-frame flag field, a destination-register field, and an immediate, source-register, or operand field.

5. The method according to claim 1, wherein the balance accumulator comprises a hardware balance register having a width of at least 128 bits.

6. The method according to claim 1, wherein performing the non-commit response comprises at least one of rolling back to a checkpoint, discarding speculative state, raising an imbalance exception, setting an imbalance flag, trapping to software, refusing execution, re-executing the current execution frame, logging diagnostic information, or entering a safe state.

7. The method according to claim 1, wherein instruction results generated during execution of the current execution frame are held in speculative state and are promoted to committed state only after the balance accumulator equals zero at the frame boundary.

8. The method according to claim 1, further comprising generating the opcode stream by a compiler that assigns balance classes to operations, partitions operations into execution frames of exactly eight opcodes, computes a signed frame balance for each execution frame, and modifies one or more execution frames until each execution frame has a signed frame balance equal to zero.

9. The method according to claim 1, further comprising verifying, by a loader or runtime verifier, ledger-conformance metadata associated with an executable artifact comprising the opcode stream before execution, wherein verifying comprises recomputing or verifying an integrity value over at least a frame-attestation table and refusing execution when the integrity value fails to match an embedded integrity value, and wherein the ledger-conformance metadata includes at least one of a frame-attestation table, a contribution-map identifier, a frame-boundary table, a proof hash, an attestation hash, a checksum, a cryptographic digest, a digital signature, a Merkle root, or a certificate.

10. A ledger-enforced computing system, comprising:
an execution engine configured to execute fixed-length opcodes, each fixed-length opcode including balance-class metadata designating a signed algebraic contribution;
a frame-boundary detector configured to identify completion of an execution frame consisting of exactly eight opcodes;
a balance accumulator configured to accumulate signed algebraic contributions of the exactly eight opcodes of the execution frame;
a zero comparator configured to compare the balance accumulator with zero at completion of the execution frame; and
commit-control circuitry configured to permit architectural state or virtual-machine state associated with the execution frame to commit only when the balance accumulator equals zero and to prevent commit when the balance accumulator is nonzero.

11. The system according to claim 10, wherein the execution engine comprises a hardware processor including an instruction fetch unit, an instruction decoder, a balance-class decoder, a signed-contribution lookup, a frame counter, a balance register, rollback checkpoint storage, and a store buffer configured to hold memory stores generated during the execution frame until the commit-control circuitry permits commit.

12. The system according to claim 10, wherein the frame-boundary detector is configured to detect a 1-bit execution-frame flag in a final opcode of the execution frame.

13. The system according to claim 10, wherein the commit-control circuitry is configured to discard speculative state or restore a rollback checkpoint when the balance accumulator is nonzero at completion of the execution frame.

14. The system according to claim 10, further comprising a virtual machine configured to interpret a bytecode or opcode stream by maintaining a software balance accumulator, accumulating signed algebraic contributions over each execution frame consisting of exactly eight opcodes, and committing virtual-machine state only when the software balance accumulator equals zero at a frame boundary.

15. The system according to claim 10, further comprising a loader configured to verify ledger-conformance metadata associated with an executable artifact and to refuse execution when verification of the ledger-conformance metadata fails.

16. The system according to claim 11, wherein the frame counter is configured to verify that a frame-boundary indication is asserted only for a final opcode slot of the execution frame, and wherein assertion of the frame-boundary indication at a non-final opcode slot causes at least one of an exception, trap, rollback, or refusal of execution.

17. A compiler system for generating ledger-conformant executable code, comprising:
one or more processors; anda memory storing instructions that, when executed by the one or more processors, cause the compiler system to: assign balance classes to operations or candidate opcodes; organize the operations or candidate opcodes into execution frames, each execution frame consisting of exactly eight opcodes; compute a signed frame balance for each execution frame based on signed algebraic contributions associated with the assigned balance classes; modify at least one execution frame until the signed frame balance equals zero; andemit ledger-conformant executable code including the execution frames and frame-boundary indications.

18. The compiler system according to claim 17, wherein modifying the at least one execution frame comprises at least one of semantic-preserving reordering, insertion of an architecturally neutral compensating opcode that changes a signed frame balance without changing program-visible state other than balance enforcement, insertion of a neutral padding opcode contributing zero to the signed frame balance, substitution of an equivalent instruction sequence, distribution of operations across adjacent frames, selection of alternative instruction encodings having different balance classes, or use of paired operations.

19. The compiler system according to claim 17, further comprising an attestation generator configured to generate ledger-conformance metadata including at least one of a frame-attestation table and a proof hash, wherein the proof hash comprises a SHA-256 hash of at least the frame-attestation table, and wherein the compiler system is configured to embed the proof hash in a ledger section or associated metadata of the ledger-conformant executable code.

20. A non-transitory computer-readable medium storing instructions or executable data configured to cause one or more processors, a loader, a verifier, a compiler, or a virtual-machine execution engine to perform operations comprising:
receiving or generating ledger-conformant opcodes organized into execution frames consisting of exactly eight opcodes;
providing or decoding balance-class metadata associated with each opcode;
accumulating signed algebraic contributions associated with the balance-class metadata in a hardware or software balance accumulator;
identifying a frame boundary of each execution frame;
committing virtual-machine state or architectural state only when the hardware or software balance accumulator equals zero at the frame boundary;
performing a non-commit response when the hardware or software balance accumulator is nonzero at the frame boundary; and
storing, verifying, or using ledger-conformance metadata comprising at least one of a frame-attestation table, contribution-map declaration, frame-boundary table, proof hash, attestation hash, checksum, cryptographic digest, digital signature, Merkle root, certificate, compiler identifier, ISA version, or executable manifest.
